(19) United States
(12) Patent Application Publication
(10) Pub. No.: US 2013/0303203 A1
(43) Pub. Date: Nov. 14, 2013

(54) PAGING AND SYSTEM INFORMATION BROADCAST HANDLING IN VIRTUALIZED NETWORKS

(71) Applicant: INTERDIGITAL PATENT HOLDINGS, INC., Wilmington, DE (US)

(72) Inventors: Guanzhou Wang, Longueuil (CA); Pascal M. Adjakple, Great Neck, NY (US); Kai Liu, S. Huntington, NY (US); Peter S. Wang, E. Setauket, NY (US)

(73) Assignee: InterDigital Patent Holdings, Inc., Wilmington, DE (US)

(21) Appl. No.: 13/891,797

(22) Filed: May 10, 2013

Related U.S. Application Data
(60) Provisional application No. 61/645,130, filed on May 10, 2012.
(60) Provisional application No. 61/706,376, filed on Sep. 27, 2012.
(60) Provisional application No. 61/721,256, filed on Nov. 1, 2012.

(51) Int. Cl. H04W 68/00

(52) U.S. Cl. CPC H04W 68/00
USPC 455/458

(57) ABSTRACT

Embodiments contemplate paging and system information broadcast handling for multi-SIM WTRUs using mobile networks to access resources and/or services. Embodiments also contemplate paging and system information broadcast handling for multi-SIM WTRUs and/or non-SIM WTRUs using mobile networks to access virtualized resources and/or services. Embodiments contemplate that a WTRU may determine to monitor a plurality of mobile networks. Paging occasions to monitor at least one of the mobile networks may be based on a common WTRU ID. The WTRU ID may be provided by a node supporting access to the virtualized resources or services. Paging occasions for a first network may be determined by a second network based on paging related parameters and other information of the first communication network. A change in system information of a first network may be signaled to a second network for indication to a WTRU.

### CROSS-REFERENCE TO RELATED APPLICATIONS

This application claims the benefit of U.S. Provisional Application No. 61/645,130, filed. May 10, 2012, titled “PAGING AND SYSTEM INFORMATION BROADCAST HANDLING FOR MULTI-SIM MULTI-STANDBY USER EQUIPMENT IN WIRELESS NETWORKS”, U.S. Provisional Application No. 61/706,376, filed Sep. 27, 2012, titled “PAGING AND SYSTEM INFORMATION BROADCAST HANDLING FOR MULTI-SIM MULTI-STANDBY USER EQUIPMENT IN WIRELESS NETWORKS”, and U.S. Provisional Application No, 61/721,256, filed Nov. 1, 2012, titled “METHODS AND SYSTEMS FOR PAGING AND SYSTEM INFORMATION BROADCAST HANDLING FOR WTRUS IN VIRTUALIZED NETWORKS”, the entire content of all three respective applications hereby incorporated by reference herein, for all purposes.

### BACKGROUND

Traditional content and service delivery models for services that are delivered through fixed and/or mobile networks may utilize various schemes to efficiently deliver and charge for the services provided. For example, services may be delivered using an “operator-specific access” model, where network-based access to the services may be tied to a specific network operator. For example, operator-specific access may be associated with the delivery of one or more services where network access is fixed to a specific network operator through one or more of a subscription-based scheme (e.g., user holds a subscription to an Internet Service Provider (ISP); user holds a subscription to a Mobile Network Operator (MNO)) and/or through a pre-paid-based scheme (e.g., user buys credit that can be used afterward to access services provided by a service provider such as a MNO or/and ISP).

In another example, services may be obtained using operator-independent delivery, where the services may be provided independent of the network operator and/or through multiple service providers. For example, social Networking (e.g., Facebook, Twitter, etc.), mailing services (e.g., Google Mail, Yahoo Mail, etc.), stock quoting services, weather services, WTRU-based location services (e.g., location services provided by Android), and/or the like may be examples of operator-independent services.

### SUMMARY

The Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments contemplate paging and system information broadcast handling for multi-subscriber identity module (SIM) wireless transmit/receive units (WTRUs) using mobile networks to access resources and/or services. Some embodiments contemplate paging and system information broadcast handling for multi-subscriber identity module (SIM) WTRUs and/or non-SIM WTRUs using mobile networks to access virtualized resources and/or services. For example, a method for managing paging may be implemented at a wireless transmit/receive unit (WTRU). Further, examples may include a WTRU in an active session with one network, while monitoring paging from the other networks. The WTRU may perform the mobility procedures and/or monitor system information change on the other networks for which it may not have a current active session.

Embodiments contemplate one or more techniques for a wireless transmit receive unit (WTRU) to determine a set of paging occasions (perhaps in some embodiments a single set) for multiple networks. One or more techniques may include the WTRU determining a WTRU ID (in some embodiments perhaps a single WTRU ID) for paging monitoring of a first network and/or a second network. The WTRU may determine a paging occasion schedule, perhaps based on the WTRU ID (an in some embodiments perhaps the single WTRU ID). The WTRU ID (e.g., a single WTRU ID) may be provided by an entity providing virtualized resources and/or services to the WTRU. The WTRU may access at least one of the first network or the second network, perhaps in order to access the virtualized resource and/or services. The WTRU ID may be a temporary International Mobile Subscriber Identity (IMSI). In some embodiments, the temporary IMSI may be associated with a lifetime time value, and perhaps after the lifetime time value may expire, the temporary IMSI may become invalid. The WTRU may receive a list of mobile networks, and the temporary IMSI may be used to access a plurality of mobile networks located in the list of mobile networks. The WTRU may receive system information for the plurality of mobile networks in the list of mobile networks from the entity providing virtualized resources and/or services to the WTRU.

Embodiments contemplate one or more techniques for a WTRU to monitor multiple mobile networks. One or more techniques may include the WTRU determining to monitor a plurality of mobile networks, and one or more, or each, of the plurality of mobile networks may provide access to virtualized resources and/or services accessed by the WTRU. The WTRU may determine a paging occasion to monitor in at least one of the plurality of mobile networks, perhaps based on a common WTRU ID. The paging occasions for one or more, or each, of the plurality of mobile networks may be determinable based on the shared WTRU ID. The WTRU ID may be provided to the WTRU by a node supporting access to the virtualized resources and/or services. The node supporting access to the virtualized resources and/or services may further provide the WTRU with system information for one or more, or each, of the plurality of mobile networks.

Embodiments contemplate one or more techniques for determining a set of paging occasions for a wireless transmit receive unit (WTRU) that may be in communication with two or more communication networks. One or more techniques may include determining a WTRU identifier (ID) for paging monitoring of a first communication network of the two or more communication networks and a second communication network of the two or more communication networks. One or more techniques may include determining the set of paging occasions based on the WTRU ID. Also, one or more paging occasions of the set of paging occasions may correspond to at least one of the first communication network or the second communication network.

Embodiments contemplate one or more techniques that may be performed by a transmit/receive unit (WTRU) in communication with two or more communication networks in an operator virtualized network environment. One or more techniques may include registering with a virtualization layer management function of the operator virtualized network environment. One or more techniques may also include obtaining system information from the virtualization layer management function, where the system information may regard at least one of a first communication network of the two or more communication networks or a second communication network of the two or more communication networks.

Embodiments contemplate one or more techniques for determining a set of paging occasions for a wireless transmit receive unit (WTRU) that may be in communication with two or more communication networks. Some embodiments may include receiving by a first communication network of the two or more communication networks information related to a second communication network of the two or more communication networks. Embodiments may also include determining the set of paging occasions by the first communication network based on the information. The set of paging occasions may correspond to the second communication network. Embodiments may also include sending by the first communication network the set of paging occasions to the WTRU.

Embodiments contemplate one or more techniques for obtaining system information from a communication network. One or more techniques may include sending a first indication from a first communication network to a second communication network, where the first indication may indicate a change in system information in at least a part of the first communication network. One or more techniques may include sending a second indication from the second communication network to a wireless transmit/receive unit (WTRU), where the second indication may indicate the change in the system information in the at least part of the first communication network. One or more techniques may also include obtaining the system information from the first communication network by the WTRU in response to the second indication.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of another example radio access network and an example core network that may be used within the communications system illustrated in FIG. 1A;

FIG. 1E a system diagram of another example radio access network and an example core network that may be used within the communications system illustrated in FIG. 1A;

FIG. 2 illustrates an example of an end-to-end architecture of a virtualized network consistent with embodiments;

FIG. 3 is an example signal diagram of a Dual-SIM Dual-Standby (DSDS) wireless transmit/receive unit (WTRU) and networks consistent with embodiments;

FIG. 4 is an example diagram of a WTRU signaling consistent with embodiments;

FIG. 5 is an example signal diagram of a WTRU, operator systems, and other components consistent with embodiments; and

FIG. 6 illustrates an example technique of temporary identifier assignment by a virtualization layer consistent with embodiments.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application. As used herein, the article “a” or “an”, absent further qualification or characterization, may be understood to mean “one or more” or “at least one”, for example.

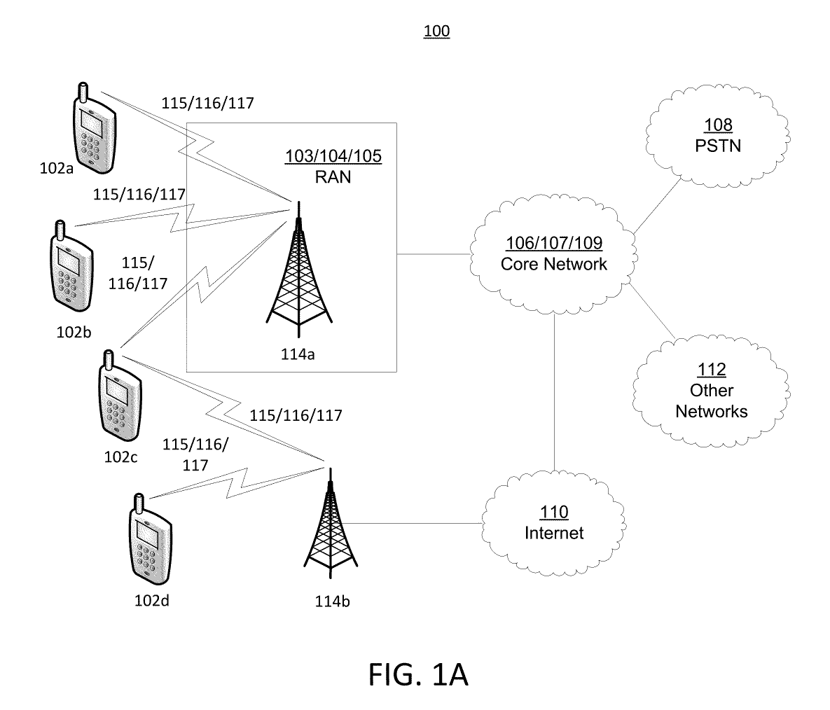

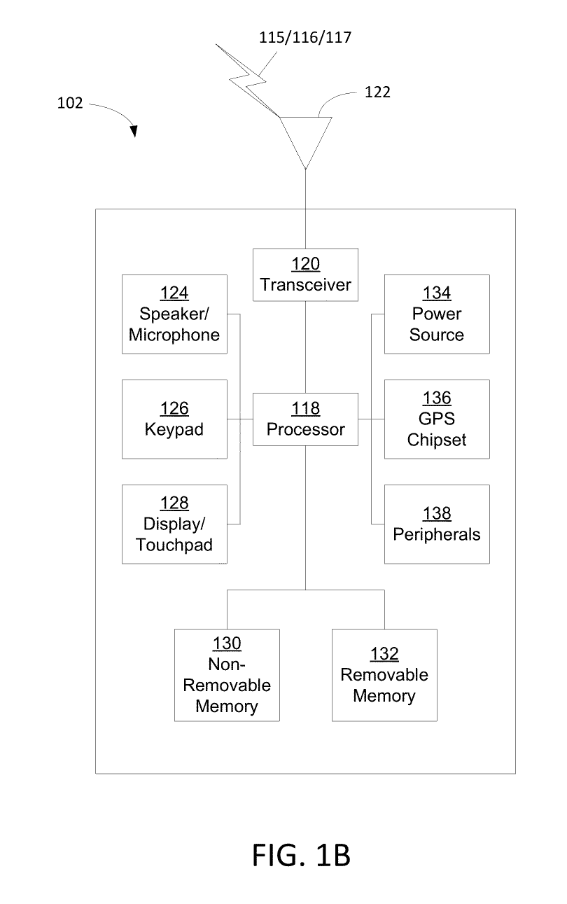

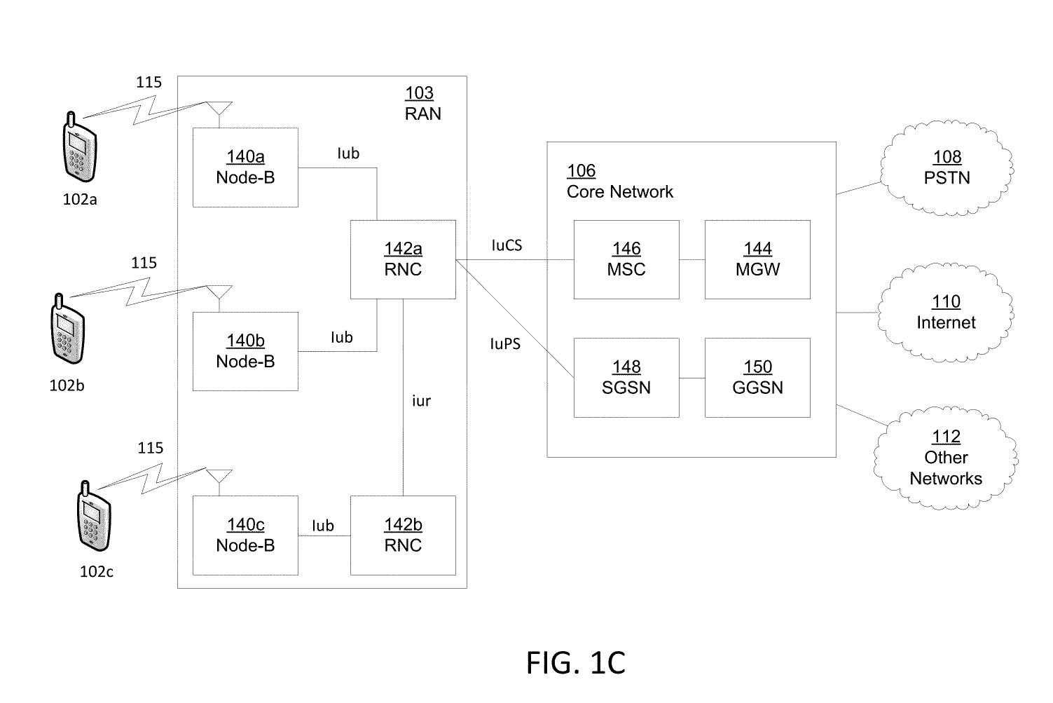

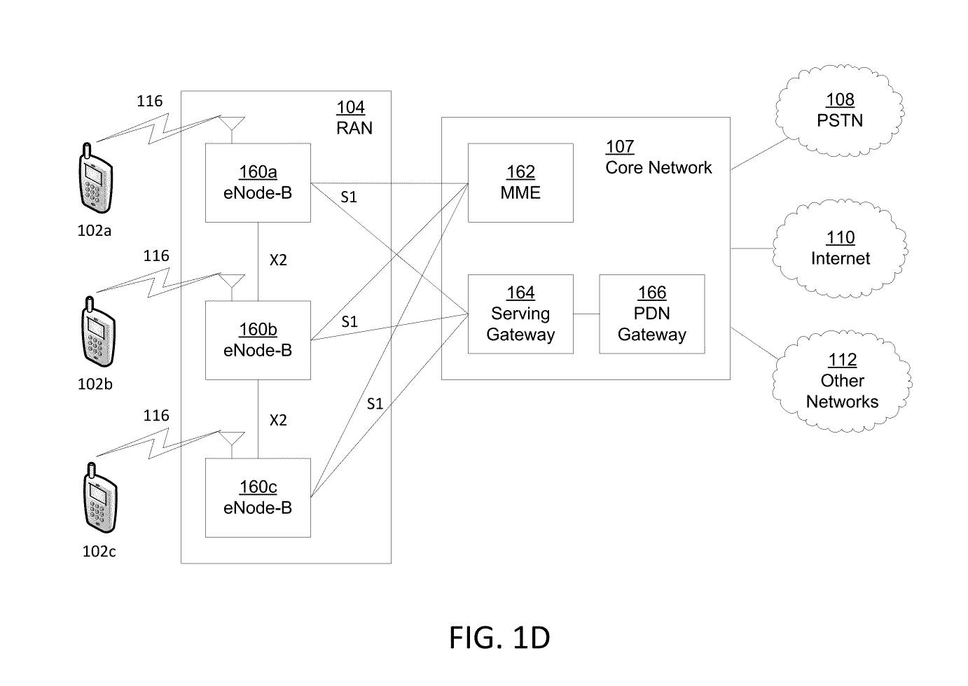

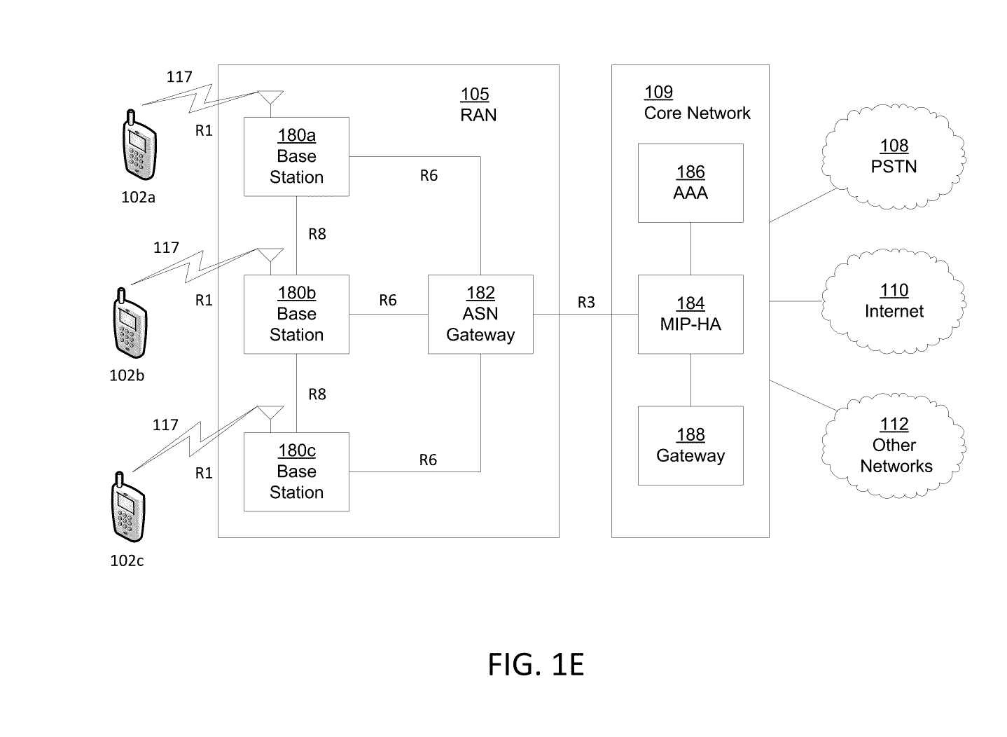

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA20001x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Embodiments recognize that the landscape in the wireless and mobile communication industry may continue to evolve at an accelerated pace. This may lead to an increase in the flexibility of data services delivery on different devices with increased integration between the different stakeholders of the industry. For example, many networks may provide support for additional (e.g., heretofore undefined) network sharing scenarios and/or enhancements to existing network sharing scenarios. For example, network operators may support techniques that may allow the sharing of multiple core networks that may share a common radio access network. Network operators may also utilize geographically split networks sharing and/or network sharing over a common geographical area. Common spectrum network sharing may also increase in use and/or importance. Some network operators may even allow for the use of multiple radio access networks that may share a common core network. Perhaps if mobile operators may be utilizing the same RAN, systems may be developed for efficiently sharing common RAN resources according to identified RAN sharing scenarios (e.g., pooling of unallocated radio resources). To facilitate this resource sharing, systems and methods may be developed to verify that the shared network elements may provide allocated resources, perhaps according to sharing agreements/policies. Perhaps to ensure proper operation during network sharing scenarios, methods may also be developed to take action upon the detection of overload situations in consideration of sharing agreements/policies.

Embodiments recognize that services may be delivered in a more efficient manner. For example, the third generation partnership project (3GPP) study on Interworking between Mobile Operators using the Evolved Packet System and Data Application Providers (MOSAP) is studying how, with the advent of new models of services delivery like cloud computing and Application Stores, a mobile operator may minimize upgrades to the network and associated backend integration. Additionally, the GSMA OneAPI Initiative is attempting to define a commonly supported set of lightweight and Web friendly APIs to allow mobile and other network operators to expose useful network information and capabilities to Web application developers, thereby creating an ecosystem conducive to a rapid and/or innovative service development and deployment across multiple network operator platforms under a uniform framework.

The emergence of Cloud Computing and Network Virtualization for wireless and mobile applications and telephony may also effecting service delivery. For example, smart phones, tablets, and/or cloud computing are converging in the rapidly growing field of mobile cloud computing.

In certain circumstances the user may enter into a service contract and/or pay for services that the user may not have received. It may also be the case that the user may pay for services that may potentially never be used (e.g., pre-paid services that are never redeemed). In a sense, the pre-paid model may be considered an attempt to provide a certain degree of freedom (or feeling of freedom) for end-users who do not want to commit to the liabilities of a service agreement. The end-user may achieve this freedom at the expense of paying costly services in advance of any use.

Multi-Subscriber Identity Modules (SIM) card terminal may also increase in number and use. Until recently, the use of Multi-SIM wireless transmit/receive units (WTRUs) has been eschewed by the larger phone manufacturers partly due to their close ties with mobile phone networks who may prefer that customers use a single network, perhaps exclusively.

Embodiments recognize that the trends may eventually lead to a change in a paradigm where the user may be able to take more control over what services are purchased, how the services may be used, and how the user may be charged. For example, a user may be able to select one or more desired services on demand regardless of which MNO offers them and/or with or without traditional cellular subscriptions. From the perspective of the user, a different approach to service or content delivery may lead to more efficient and cost-effective access to the services by a WTRU.

Embodiments contemplate that one or more service delivery paradigms that may be focused on user controlled service delivery may facilitate one or more of the results described herein. For example, one or more services may be provided to an end-user, perhaps in some embodiments based on subscriber desires, and perhaps in some embodiments not on MNO capabilities. Users may engage in ubiquitous network accessibility, where services may be delivered anywhere, anytime, and/or to any user, perhaps based on user credentials and/or the ability of the user to pay without reliance on an MNO as “middle man” and/or without a prior subscription, or a prior service agreement. Such delivery may avoid network limitations and may enable access to multiple networks, better QoS (e.g., higher data rates) and/or better network utilization. In roaming scenario embodiments, the paradigm change may result in the end-user being charged while roaming based on the desired services rather than, or in addition to, the location where these services are delivered.

In one or more embodiments, the content delivery techniques may be hidden to the user. For example, one or more of the content delivery techniques described herein may provide a consistent user experience where the underlying network and/or service complexity may be hidden to the user, perhaps while satisfying the content and/or service delivery desires of the user. In some embodiments, these features may be achieved, perhaps while allowing network operators to profit from services running across their networks. One or more of these techniques may allow a user to access any service, anywhere, and/or anytime, perhaps based on the user credentials and/or an ability to pay without a prior subscription to an operator.

For example, one or more of the techniques described herein may allow service providers to offer services that include the service and/or the access network (e.g., Google, Yahoo, Apple, and/or Facebook, etc.). Network operators may offer network one or more resources for service providers. For example, equipment vendors may offer professional services, including operating the network, using the architectures described herein.

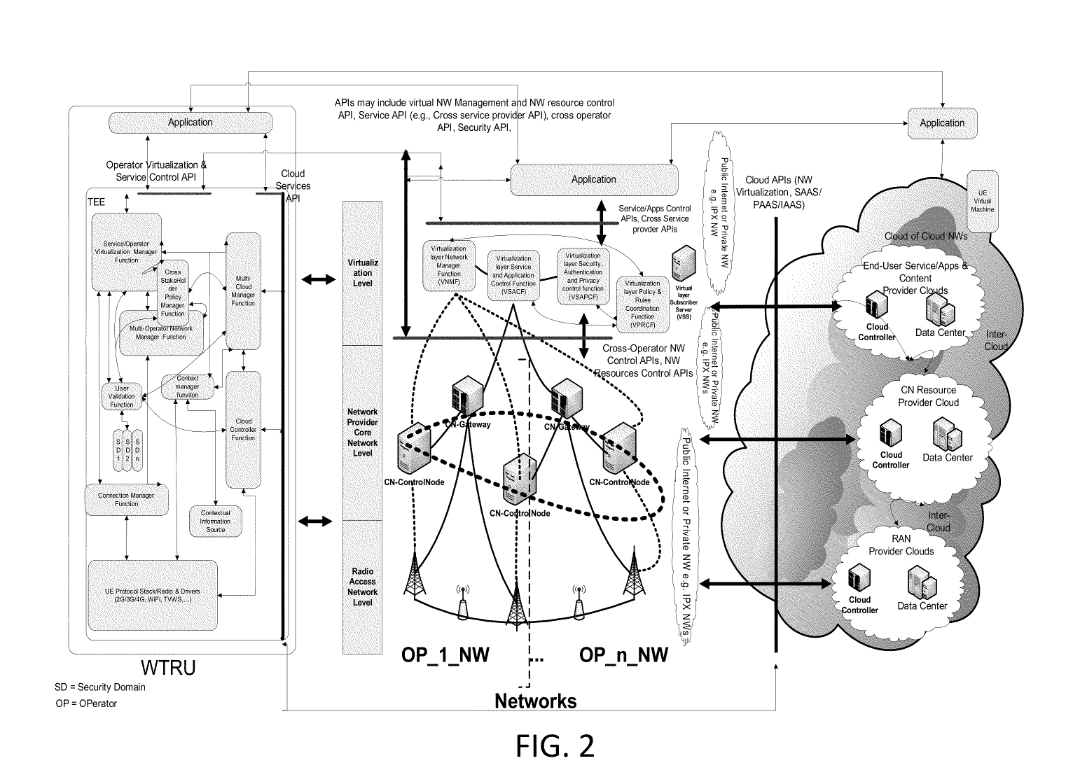

FIG. 2 illustrates an example of an end-to-end architecture of a virtualized network that may include WTRU architecture and network architecture. For example, the architecture of FIG. 2 may be considered a multi-dimension virtualization architecture, where the WTRU may access the network on a service basis, perhaps in some embodiments regardless of the operator network used, the service provider used, and/or the radio access technology used. This “network of networks” may include, by way of example, a radio access network, a core network, a service network, and/or a cloud network. In some embodiments, the one or more operators may be virtualized. In some embodiments, the one or more service providers may be virtualized. In some embodiments, the one or more WTRU resources (e.g., computation resources, storage resources, networking logic, protocol and algorithms logic, etc.) and/or one or more radio access network resources with perhaps one or more different air interfaces (e.g., GSM, CDMA, WCDMA/HSDPA/HSUPA, TD-SCDMA, LTE, WiFi, WiMax, etc.) may be virtualized into the cloud. An example of a use case in support of such network resource virtualization in the context of the radio access network may be the case of reconfigurable radio systems. By virtualizing one or more network operators, service providers, and/or WTRU resources, systems may be provided to offer an operator agnostic, technology access agnostic, and/or service provider agnostic network access and/or service access. For example, a layer of the radio protocol stack could be dynamically reconfigured with one or more of contemplated protocol logic, contemplated baseband and/or radio processing algorithms, contemplated operation frequency spectrum, and/or operation bandwidth located in the cloud.

In one or more embodiments, one or more network resources may be virtualized in the sense of dynamic resource pooling across one or more networks. An example use case for such scenarios may be the sharing of radio access network resources (e.g., spectrum, radio resource block, cells, etc.). In one or more embodiments, one or more WTRU resources (e.g., computation resources, storage resources, networking logic, protocol and algorithms logic, etc.) may be virtualized into the cloud. An example of a use case in support of such network resources virtualization in the context of the radio access network may be the case of reconfigurable radio systems. In one or more embodiments, one or more services (e.g. business logic) that may be provided to the users and/or other business support services (e.g. charging and billing support system, operator support system, etc.) may be virtualized into the cloud. One or more of the embodiments (in any combination) may be integrated and/or activated together, for example as depicted in FIG. 2 (where TEE may refer to a Trusted Execution Environment). In other example architectures, a subset of the embodiments may be realized.

Embodiments contemplate one or more of the following scenarios, perhaps when delivering services to the WTRU, among other scenarios. For example, in some scenarios a WTRU may have a subscription with a network operator and may be provided with a SIM-like integrated circuit card (ICC) (e.g., Universal Integrated Circuit Card (UICC) or a device configured with a SIM function). For example, one or more SIM card and/or SIM-like ICCs may be provided to the WTRU. In some scenarios, a WTRU may have a subscription, but perhaps may not be provided with a SIM-like ICC (or a device configured with a SIM function). In some scenarios, a WTRU may lack a subscription and may not be provided with a SIM-like ICC. In some scenarios, a WTRU may lack a subscription but may be provided with one or more SIM-like ICCs (e.g., UICC). One or more of these scenarios may be implemented by using one or more of the various techniques and systems described herein.

For example, credit card-based subscriptions may be utilized. For example, the subscriber may obtain a Credit Card from a financial Institution (FI). A SIM-enable credit card may be provided to the subscriber. During transactions or service requests, the MNO and/or FI may implement bank-transaction based dynamic charging. For example, pre-paid subscriptions may be utilized. The pre-paid subscription may or may not be operator based (e.g., may be non-operator based). For example, the subscriber may purchase a loadable USIM enabled Debit Card and/or the subscriber may purchase a prepaid credit through a service such as Paypal. A MNO may implement bank-transaction based dynamic charging.

By way of further example, the use of one or more surrogate Mobile Network Operators (MNOs) may be utilized. For example, the subscriber may subscribe to a surrogate network operator and may utilize one or more services from other network operators or service providers using the subscription with the surrogate network operator.

Also by way of example, third party authentication may be utilized. For example, the user may determine to purchase services from different networks from which the user may lack a subscription. A third-party may be used to authenticate the network to the subscriber and the subscriber to the network. After authentication is complete, the subscriber may purchase services from the network operators via a service such as PayPal and/or using a credit card. In the context of the architecture illustrated in FIG. 2, such a third party authentication entity may be an IP provider, a service broker, a financial institution, and/or any entity that may operate from the virtualization layer level.

Home Network-Assisted Subscriptions may be utilized. For example, the subscriber may be roaming in a visited network. To avoid high roaming charges from the subscriber's home network operator, the subscriber may desire to purchase service directly from the visited network operator directly. The subscriber's home network operator may authenticate the visited network and/or the subscriber. Perhaps, after the authentication, the subscriber could purchase services from the visited network operators via services such as PayPal, using a credit card, etc.

In one or more embodiments, “SIM” may be used to reference a subscriber identity module application (e.g., running on a 3GPP ICC such as UICC) and may be in reference to 2G/2.5G SIM, UMTS/LTE SIM (e.g., USIM), ISIM (e.g., IMS SIM), RUIM (removable user identity module), SIM application toolkit, and/or the like, for example.

In one or more embodiments, operator virtualization may be referred to interchangeably as multi-operator device access, service based access, operator agnostic network access, operator and access technology agnostic network access, operator and service provider agnostic network access, operator and service provider and technology agnostic network access, and/or the like. The operator virtualization may be achieved with or without prior subscription to the network operator(s) whose network(s) may be accessed and/or with or without SIM card/UICC from the operator(s) whose network(s) may be accessed. Virtualized network resources may be accessed by a WTRU. WTRUs that access virtualized resources may also be referred to as OADs (operator agnostic access devices) or WTRUs capable of operating in a virtualized network (e.g., networks where the operators are virtualized).

Embodiments recognize that, with the development of mobile communications, a variety of wireless cellular standards have been developed, such as but not limited to GSM, CDMA (IS-95), WCDMA, CDMA2000, TD-SCDMA, and LTE. Different mobile service providers may operate a network of different technologies and standards, and/or an operator could run two or more cellular networks of different standards. A mobile user could subscribe with two operators to benefit from different technology and/or a differentiated service and rate. To facilitate such users, embodiments recognize the use of dual-SIM dual-standby (DSDS) mobile phones which may have two SIM cards installed at the same time so the user can communicate with either of the two networks. Perhaps for the sake of lower cost, DSDS cell-phones may have a single radio front-end, meaning that they may be unable to communicate with the both networks simultaneously. Embodiments recognize one or more combinations of the technologies and standards of the two networks that the two SIMs may be subscribed to, such as GSM+CDMA, GSM+WCDMA, LTE+WCDMA and so on.

In one or more embodiments, Dual-SIM Dual-Standby (DSDS) may be used as an example for purposes of description and illustration. In some embodiments, the described examples may also apply to other Multi-SIM Multi-Standby cases (e.g., more than 2 SIMs, etc.).

In some embodiments, the DSDS WTRU may possess a single radio front-end and base band processing chain, and may be registered in two networks simultaneously, but the WTRU may be in an RRC Connected state for a single network at a time. The WTRU may attempt to monitor paging and/or other information from the other network. For example, in order to monitor pagings from a first network while being connected in an RRC Connected state to a second network while using a single radio front-end (RFE), the WTRU may have gaps on the active connection. The WTRU may drop the data connection on the second network, perhaps when the WTRU may receive a paging on the first network. This kind of WTRU may not be fully standard compliant and/or may cause decreased performance and/or reduced system capacity in the second network. The DSDS WTRUs with this type of behavior may be referred to as the “Dual Standby, Single Connection” (DSSC) WTRUs.

In some embodiments, the DSDS may be another type of WTRU which may be referred to as a Dual SIM Active, (DSA) WTRU. A DSA WTRU may include two or more working radio front-end transceivers and/or base band processing chains that may allow the device to be connected to both networks at the same time. For example, a DSA WTRU user may switch between calls (e.g. one call on each respective network) without dropping either call. In such embodiments, the phone may be allowed to answer two calls at the same time. For example, DSA WTRUs may allow a user to receive signals for both numbers. DSDS WTRUs with this type of behavior may be referred to as the “Dual Standby, Dual Connection” (DSDC) WTRUs.

In some embodiments, Dual-Standby may include dual-standby while in IDLE mode and/or real dual-standby even when the WTRU may be engaged in an active session with one or more of the networks. A dual standby scenario wherein the WTRU may be connected to a first network while monitoring a second network may include a WTRU monitoring the paging from the second network even when it may be in an active session with the first network. Perhaps in such embodiments, the WTRU may have trouble receiving data from network A (e.g., the first network with which the WTRU may be in an active session) during the time occasions when the WTRU may be configured to monitor the paging from network B (e.g., the second network). In order to avoid these complications, among other reasons, network A may be informed as to when the WTRU may be switching to another network (e.g., network B). In such scenarios, network A may use this knowledge to stop scheduling the WTRU during one or more paging occasions, for example perhaps in order to avoid data transmission failures on network A during paging occasions for network B.

In some scenarios, as stated above, the active communication on network A may be frequently interrupted when the WTRU may switch to another network to monitor paging messages from time to time, and perhaps due to the length of the switching time, the real interruption time could be longer than the paging monitoring time. This may impact the performance and/or user experience of the ongoing active session. The extra paging monitoring may also incur extra power consumption.

In some embodiments, certain difficulties may be common to both IDLE mode multi-standby and/or connected mode multi-standby. For example, techniques may be utilized in order to avoid a DSDS WTRU from dropping ongoing calls from a first network when a page may be received from a second network. For example, a dual-SIM Dual-Standby (DSDS) WTRU may register in two networks simultaneously with just a single radio front-end and/or base band chain. The DSDS WTRU may be RRC Connected to a single network at a time. In some embodiments, the WTRU may be able to monitor the paging message from the other network. When the WTRU receives a page on the second network, it may (e.g., perhaps depending on implementation and/or configuration) drop the (data) connection on the first network. In some embodiments, the paging message may not contain information related to the importance and/or reason for the page. In such scenarios, the WTRU may be unable to make an informed decision regarding whether or not the original call may (or perhaps in some embodiments, should) be dropped.

In some embodiments, Dual-SIM WTRUs may allow the use of both networks, maybe for different service and/or for a different price plan, without carrying two phones. Perhaps due to manufacturing cost, some of the dual-SIM WTRUs may have a single radio front-end and/or base band chain. In an Idle mode, such a WTRU may monitor paging from both networks and/or may maintain reachability by both networks by monitoring the neighboring cells and/or performing one or more Idle mode mobility procedures on two networks. The battery life (e.g., talk time and standby time) of active dual-SIM mobile phones may be reduced by 30% by performing one or more Idle mode functions for each network.

In some embodiments, techniques may be utilized to avoid a DSDS WTRU from adversely affecting the performance of the current core network. Perhaps because some of the Dual-SIM WTRUs may have a single radio front-end, when the WTRU enters connected mode with one network, it may use autonomous gap(s) to monitor another network. Perhaps to support IDLE mode mobility in another network, among other reasons, the WTRU may read the paging information and/or the system information from a second network. Perhaps when a WTRU may attempt to read system information, among other scenarios, the WTRU may stop monitoring the first (active) network for a gap period (e.g., about one second or more), which may result in an error case in the active network, for example if the active network may attempt to contact the WTRU.

In some embodiments, perhaps if the WTRU may be in active session with network A and there may be a system information change on network B, the WTRU may miss the change notification. Even if the WTRU may receive the change notification, the WTRU may be unable to read the updated system information right away, perhaps because doing so may cause an interruption (e.g., a relatively long interruption) to the current communication. For example, when the WTRU may attempt to communicate with the other network, it may use the wrong system information and perhaps fail.

Embodiments contemplate that one or more paging procedures may be affected by network virtualization. For example, one or more “paging occasion” may ensure that a WTRU may be able to receive paging transmissions, perhaps in some embodiments without monitoring the paging channel for periods of time (e.g., extensive periods of time or perhaps or all the time), which may reduce power consumption. In the case of operator virtualization (e.g., an operator agnostic network), “paging occasion” may be useful, and embodiments contemplate one or more techniques for defining paging occasions. Moreover, as the network may accommodate traditional WTRUs and/or operator agnostic network capable WTRUs (e.g., WTRUs capable of operating in virtualized operator networks), one or more embodiments contemplate considerations to provide backward compatibility.

Some networks may use the IMSI of the WTRU to calculate the paging occasions specific to the WTRU at the network side and/or the WTRU side. Embodiments recognize that, perhaps in scenarios where the operators may be virtualized and/or where the WTRU may lack a SIM Card (e.g., which may include that the WTRU may lack an IMSI and/or may lack a permanent IMSI), determining paging occasions based on IMSI may lead to difficulties. One or more embodiments contemplate techniques for determining paging occasions in such scenarios. Furthermore, in some embodiments such techniques may be configured to coexist with traditional paging mechanism(s).

In an operator agnostic network, a WTRU may not be associated or linked to any specific network operator, as it may achieve access through “any” available network. An incoming call may not be destined to a known network and may come through an unpredictable network. An operator agnostic network capable WTRU may be able to monitor paging for multiple networks, for example both in IDLE mode and/or connected mode. Embodiments contemplate techniques and systems for such monitoring that may take place on multiple networks, on a selected networks, and/or on a selected subset of networks, as well as one or more rules that may be useful (e.g., for network selection and paging monitoring).

Embodiments recognize that WTRUs may respond to the paging requests and access the specific network from which the paging may come. For a WTRU in an operator agnostic network, the paging may come from various networks, and the user may have a specific preference on using a specific network. Thus, the WTRU may access a network that may be different than that of the paging network (e.g., the network issuing the page) in order to respond to the page.

Perhaps in order to be able to access any network at any time, among other reasons, an operator agnostic network capable WTRU may keep updating system information (SI) of multiple networks. In some embodiments, it may be impractical to acquire SI of many or all available networks. For example, the WTRU may follow one or more rules that may limit the SI acquisition, for example to a few selected networks. Embodiments recognize that it may be challenging to monitor the change and/or update the SI of other networks while the WTRU is in connected mode. One or more embodiments contemplate techniques may for WTRU operation with regards to idle networks while the WTRU may be actively connected to another network.

The systems and techniques described herein may apply to multi-SIM WTRUs or/and the scenarios including operator virtualization and/or other virtualization scenarios. Although one or more examples described herein may be in terms of use cases for multi-SIM WTRUs, systems and methods described herein may be equally applicable to and extended to virtualization cases. For brevity, in the following example descriptions, the “Network A” may refer to the network that the WTRU may currently be within in an active session, and the “Network B” may be another network that the WTRU may be on stand-by for and/or for which the WTRU may monitor the paging activity.

When described herein, a WTRU that may be in “IDLE mode” may be IDLE on both networks (e.g., Network A and Network B). The WTRU may be in “Active mode” when it may be connected to at least one network.

In one or more embodiments, the WTRU may report the paging related parameters of network B to network A, so network A may determine on what (one or more) time occasions the WTRU may switch to network B, and perhaps be unable to receive data from network A. The WTRU may notify network A of its dual-standby capability and/or preference.

The dual-standby capability information may include one or more of an indication of support for dual-standby in IDLE mode, for example. In some embodiments, the information might or might not include an indication of support for active mode and/or an indication of support for dual-standby in Active mode. The dual-standby preference information may include one or more of an indication of a preference to monitor the other network in Active mode and/or an indication of a preference to refrain from monitoring the other network in Active mode.

By way of further example, the WTRU may also send network A one or more of the following information: the priority of network B for which the WTRU may be on stand-by (e.g., higher or lower); the technology and/or standards of network B (e.g., GSM or UMTS); the identification of the operator of network B; and/or the WTRU identifications of network B (e.g., IMSI, TMSI, P-TMSI, GUTI, and the like). For example, the identification could be a heretofore undefined identification that may be specified for the support of Dual-SIM Dual-Standby devices. The WTRU may send network A an indication of the rules and/or policy configuration of network B (e.g., in support of Dual-SIM Dual-Standby devices) and/or a list of neighboring networks that may support Dual-SIM Dual-Standby operation.

In some embodiments, for example in some virtualization cases, the WTRU might or might not have a unique IMSI for one or more, or each, network. In some embodiments, perhaps rather than or in addition to, an IMSI for one or more, or each, network, the WTRU may have a common IMSI for some or all of the networks, which in some embodiments may be assigned by a party in the virtualization layer. In such scenarios, among other scenarios, the reported IMSI of the network B may be same as that of network A.

In some embodiments, Network A may broadcast its support for dual-standby in the system information. The support may be indicated by at least one bit (e.g., 1 may mean the WTRU supports DSDS and/or 0 may mean that the WTRU may lack support for DSDS) and/or using a bit map (e.g., the bits in the bit map may represent one or more supported types of RATs (e.g., LTE, UMTS, GERAN, etc.) and/or networks for dual-SIM). The broadcast by Network A may indicate whether support may be between same technology networks (LTE/LTE, UMTS/UMTS, GERAN/GERAN) or mixed technology networks (e.g. LTE/UMTS, LTE/GERAN, UMTS/GERAN, etc.). The broadcasted dual-standby information may include one or more of: the technology and/or standards of network B that may be supported, an indication of support for dual-standby in IDLE mode (perhaps IDLE mode alone), an indication of support for dual-standby in active mode (perhaps active mode alone), and/or an indication of support for dual-standby in IDLE mode and/or active mode (e.g., which in some embodiments may be implicitly signaled by indicating support got dual-standby in active mode).

In one or more embodiments, the network may broadcast its support for network virtualization. For example, the support network may indicate its support of network virtualization by transmitting and/or broadcasting at least one bit (e.g., 1 may mean the network supports network virtualization and/or 0 may mean that the network may lack support network virtualization) and/or a bitmap. The network may indicate whether the support for network virtualization may be between the same technology networks (LTE/LTE, UMTS/UMTS, GERAN/GERAN) or mixed technology networks (e.g. LTE/UMTS, LTE/GERAN, UMTS/GERAN, etc.). For example, the broadcasted indication of virtualization support information may include one or more of: the technology and/or standards of other networks that the current network may support the virtualization of, an indication of support for network virtualization in IDLE mode (perhaps in some embodiments not in connected mode), and/or an indication of support for network virtualization in Active mode.

In one or more embodiments, a WTRU may send the paging related parameters (e.g., paging DRX cycle, index of selected SCCPCH, and/or the like) of network B to network A, so network A may determine the paging occasions when then WTRU may switch to network B for monitoring the paging channel. In some embodiments, the paging parameters of network B may be different, perhaps depending on the technology and/or standard of the network.

The WTRU may also report to network A the radio frame timing difference, e.g., the time difference between the boundaries of the radio frames, between the two networks. The WTRU may send to Network A any other information that may be used by network A to effectively understand the timing of network B and/or to avoid network B paging occasions for this specific WTRU.

In some embodiments, perhaps when the paging parameters of network B and/or the radio frame timing difference may change, among other scenarios, the WTRU may update network A with the new (e.g. changed or fresh) value.

In one or more embodiments, the WTRU may also report to network A its IMSI for network B and/or the value of the IMSI after one or more arithmetic operations. In some embodiments, the WTRU may supply network A with any information that may allow the network A to derive the WTRU IMSI in network B and/or that can be used by the network A as a substitute of the IMSI for the computation of network B paging occasion for this specific WTRU and/or any other WTRUs. For example, if network B may be a UMTS network, the WTRU may report (IMSI div K) (e.g., a suitable paging occasion calculation formula may be utilized with this information as described herein). If a common IMSI may be used in the network virtualization case, the IMSI of Network B might or might not be unique to Network B and the common IMSI may be used in other networks (e.g., Network A).

The network may calculate the WTRU's paging occasions of network B according to one or more of: the paging parameters, radio frame timing difference, IMSI of network B, and/or other information reported by the WTRU. Network A may map the calculated paging occasions of network B to the radio frames and/or sub-frames of network A. In some embodiments, perhaps taking into account the switching time for the WTRU to switch between the two networks, network A may know the time occasions that the WTRU might be unable to receive in network A. Network A may determine to not schedule the WTRU for any transmission in those time occasions.

In one or more embodiments, network A may indicate to the WTRU, perhaps after determining the network B paging occasions for the WTRU, a subset of these paging occasions that the WTRU may be allowed to use for monitoring of paging occasion on network B. Such a subset might or might not be one or more of the possible Network B paging occasions (e.g., may be less than all the available occasions). For example, if network A may have priority over network B in general, or if network A may have a priority over network B for the service (or signaling) that may be currently in use by the WTRU on network A, network A may allow the WTRU to monitor a subset of possible paging occasions on network B. In some embodiments, the network A may deny a request by the WTRU to monitor paging occasions on network B all together (in other words, the subset may be none of the paging occasions).

For example, if network A may have priority over network B in general or network A may have a priority over network B for the service (or signaling) that may be currently in use by the WTRU on network A, then network A may deny the request by the WTRU to monitor pages on network B. Such a priority scheme may be configured by the user and communicated to the networks and/or be negotiated between the WTRU and the networks. In some embodiments, the WTRU may determine the subset of paging occasion to monitor on either network. For example, the WTRU may monitor every other paging occasion and/or may skip certain paging occasions. By way of further example, the WTRU may skip every third occasion, every fifth occasion, etc. Again by way of example, the WTRU may utilize two paging occasions, then skip the next two (then repeat). This may also be the case for three consecutive paging occasions (or four, or five, etc.).

In some embodiments, network A may inform network B via inter-network signaling that the WTRU may be active with network A and/or may inform the network B when the WTRU becomes IDLE.

In some embodiments, Network A may include the WTRU's identification in the other network B when contacting network B, perhaps in order for network B to identify the WTRU in question. Network A may include the type of service that the WTRU may be engaged in network A, so network B can decide whether the paging may be held so as to not interrupt the service. Upon receiving information regarding the WTRU/Network A, network B may refrain from sending the WTRU a page, perhaps until the WTRU may be IDLE again in Network A. For example, if there is a paging request for the WTRU on network B, network B may send the page, but perhaps may do so according to a second paging discontinuous reception (DRX) cycle that may be longer than a normal paging cycle. In some embodiments, Network B may ignore the information received from network A and may perform the paging as may be usually conducted. In some embodiments, Network B may send the paging information to network A that can then send the paging information to the WTRU. For example, Network B may send Network A a transparent container that may encapsulate the paging information and which may be forwarded to the WTRU.

In some embodiments, network B may feedback one or more decisions regarding its paging schedule to network A. For example, if network B determines to hold paging while the WTRU may be active with network A (e.g., refrain from sending pages), network A may inform the WTRU to stop monitoring the paging of network B while the WTRU is active with network A. In some embodiments, perhaps if network B may determine to use a longer paging DRX cycle length while the WTRU may be active with network A, network A may notify the WTRU of the new (e.g. fresh or updated) cycle length.

In some embodiments, network A may ask network B to use a default IMSI value (e.g. IMSI=0) for the calculation of paging occasions of the WTRU. In such scenarios, the WTRU may avoid sending its real IMSI to network A to calculate its paging occasions. This may help prevent the security of Network B from being compromised by sending IMSI over the air interface.

In some embodiments, network A and network B may share the same RAN node (e.g. eNodeB). In such scenarios, the one or more techniques described herein may be further optimized. For example, the WTRU may refrain from reporting the paging parameters and/or the radio frame timing differences. Instead, in some embodiments, the RAN node may autonomously adjust its behavior, perhaps based on its scheduling knowledge of network A and/or network B.

In some embodiments, network B may autonomously determine to indicate its paging schedule for the WTRU to network A. For example, network B may send a request to network A asking for a notification if the WTRU becomes active in network A and/or if the WTRU location becomes known to network A. Perhaps upon reception of a notification from network A that the WTRU may be active with network A and/or the location of the WTRU may be known to network A, among other reasons, network B may page the WTRU through network A. Such paging information may re-use the legacy paging information elements and/or may use an information element (for example, a bit indication and/or network B identification) that may be designed for paging via a second network (e.g., Network A).

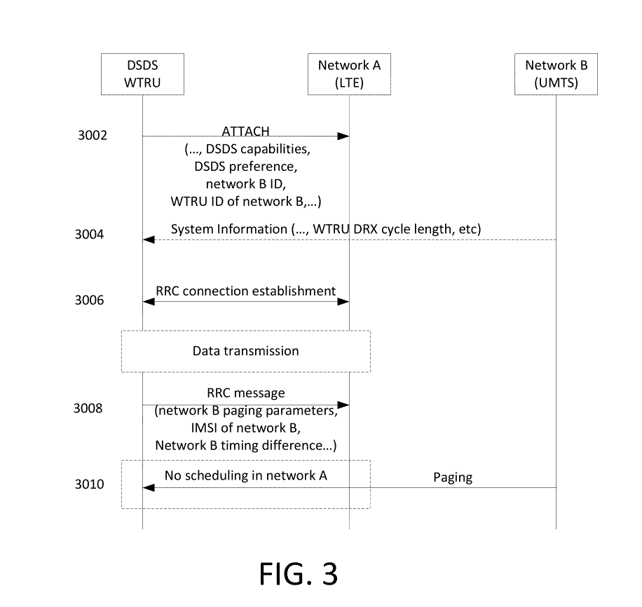

FIG. 3 illustrates an example signal diagram for coordination of paging between a DSDS WTRU and two radio access networks. Referring to FIG. 3, at 3002, the DSDS WTRU may report to network A its DSDS capabilities, DSDS preferences, the ID of network B, the WTRU ID of network B, and/or other related parameters. For example, the information may be sent in an ATTACH message, TAU, and/or other NAS procedure messages. In another example, the information may be sent during an RRC connection establishment procedure.

At 3004, the idle WTRU may receive the system information from network B including the paging related parameters such as but not limited to DRX cycle length, and the like.

At 3006, the WTRU may establish an RRC connection with network A and may start the data transmission/reception with network A.

At 3008, the WTRU may report to network A the paging parameters of network B and/or other information, such as but not limited to the timing difference between the two networks. Perhaps upon receipt of this information, among other scenarios, network A may determine the time occasions that the WTRU may use to switch to network B for paging monitoring.

At 3010, perhaps during the paging occasions of network B as may be determined by network A, network A may stop scheduling the WTRU and the WTRU may switch to network B to monitor the paging.

In some embodiments, the WTRU may calculate the paging occasions of network B and/or send an indication of network B paging occasions to network A. Such information may be communicated to network A via a heretofore undefined and/or an existing RRC signaling, and/or NAS signaling, and/or MAC signaling, for example. For example, the WTRU may send paging occasion information for network B as part of the RRC Connection Setup Complete message and/or RRC Connection Request message. The eNB may relay the information to the core network (e.g. MME) in an existing SLAP message or a heretofore undefined SLAP message.

In some embodiments, an example of NAS signaling may be the WTRU sending the paging occasion information of network B to network A in the ATTACH REQUEST message, (EXTENDED) SERVICE REQUEST message, TRACKING AREA UPDATE REQUEST message, UPLINK NAS TRANSPORT message, and/or UPLINK GENERIC NAS TRANSPORT message.

In some embodiments, the WTRU may send network B paging occasion information to network A at the time when the WTRU may transition from EMM-DEREGISTERED state (e.g., in network A) to EMM-REGISTERED state (e.g., in network A). The WTRU may send network B paging occasion information to network A at the time when the WTRU may transition from EMM-IDLE state to EMM-CONNECTED state.

In one or more embodiments, the WTRU may send network B paging occasion information to network A anytime network B may communicate to the WTRU. For example, WTRU may send network B paging occasion information to network A anytime network B may communicate new (e.g., fresh or updated) DRX parameters to the WTRU.

In one or more embodiments, the WTRU may send network B paging occasion information to network A when the WTRU may transition from RRC_IDLE state to RRC_CONNECTED state.

In some embodiments, the WTRU may convert the paging occasion of network B into a network A frame reference and/or a network A timing reference, perhaps before transmission to network A. In some embodiments, such conversion may be done at the WTRU, in which the WTRU may take into account the frame timing offset between network A and network B. Such offset maybe expressed in an SFN-SFN offset with a frame level granularity, sub-frame level granularity, time slot level granularity, and/or symbol level granularity.

In some embodiments, network A, perhaps upon reception of network B paging occasion information from the WTRU, among other reasons, may determine to not schedule the WTRU for downlink reception and/or uplink transmission during those paging occasions.

In some embodiments, network A may inform network B of the DRX settings for the WTRU in network A, perhaps so that network B may be able to page the WTRU during the DRX OFF period for network A. In some embodiments, although the WTRU may miss the occasional page from the network B (e.g., the page may come in during a DRX ON period for network A), one or more techniques described herein may facilitate that the WTRU operation in network A may not be interrupted.

In one or more embodiments, the WTRU may autonomously switch to network B to monitor the paging during its DRX_OFF period in Network A. Embodiments recognize that if the paging from network B may happen within the WTRUs active time in network A, the WTRU may be unable to receive it. One or more embodiments contemplate techniques to increase the chance for the WTRU to receive the paging during the DRX_OFF period, for example.

Alternatively or additionally to the stand-by capability and preference information described herein, the WTRU may report its support for monitoring paging of an idle network during DRX_OFF period of an active network.

In some embodiments, the WTRU may also report to network A the radio frame timing difference (e.g., the time difference between the boundaries of the radio frames) between the two networks.

In some embodiments, the WTRU may report to network A its location information for network B and/or the ID/address of the WTRU's previous mobility management entity in network B.

Network A may inform network B via inter-network signaling that the WTRU may be active with network A, and/or may inform the other network when the WTRU may become IDLE. Network A may include the WTRU identification within the network B, perhaps so that network B may identify the WTRU in question, among other reasons, for example.

Network A may also indicate one or more of the radio frame timing differences as may be reported by the WTRU and/or the WTRU's DRX settings in network A to network B.

In some embodiments, perhaps upon receiving at least some of the aforementioned information, network B may be able to determine the WTRU's DRX_OFF period in network A and may map the network DRX_OFF period to the radio frames or sub-frames of network B, for example. In some embodiments, network B may send the paging message to the WTRU when the paging occasions are within the WTRU's DRX_OFF period with network A, for example until the WTRU may be IDLE again. In some embodiments, network B may respond to network A that it has activated the special paging during DRX_OFF periods. In some embodiments, network A may notify the WTRU that the special paging in DRX_OFF periods has been activated in network B. In some embodiments, the WTRU may switch to network B to monitor paging when its paging occasions may coincide with the DRX_OFF period for Network A.

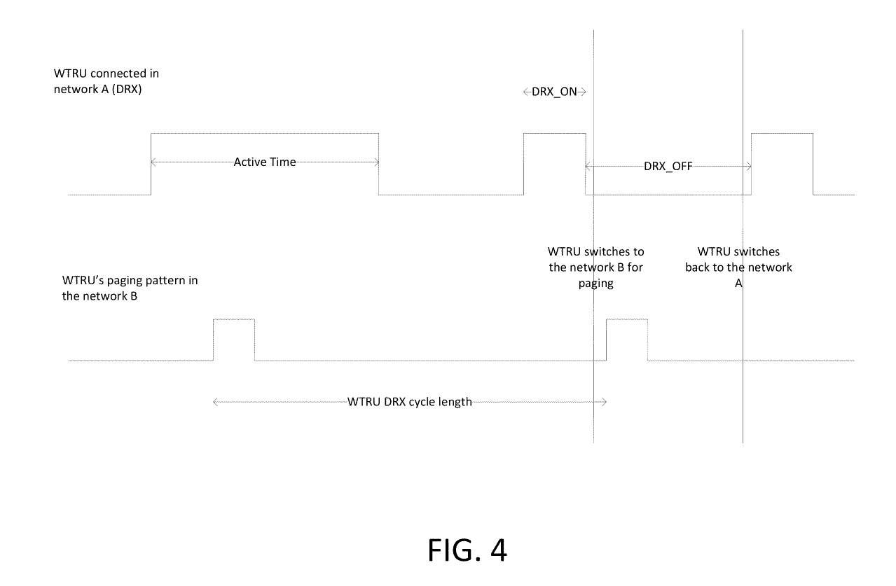

FIG. 4 illustrates an example timing for a WTRU that may determine a paging occasion, perhaps based on the DRX settings of an active network.

In one or more embodiments, network B may route a paging request to network A via inter-network signaling, perhaps when the WTRU may be active in network A. Network A may send the paging notification to the WTRU via NAS, RRC signaling, and/or user plane data.

Network A and network B may use the same or different radio access technologies and/or may have the same or different mobility management entities. For example, the two networks may both be GSM networks, one may be a GSM network and the other may be W-CDMA network, one may be W-CDMA network and the other may be LTE/EPC network, etc. One or more embodiments may assume that there may be an interface between the mobility management entities of the two networks. For example, the interface may be one or more of: the Gs interface between MSC/VLR and SGSN, the Gn interface between SGSN and SGSN, the S3 interface between SGSN and MME, and/or the S10 interface between MME and MME, and/or the like.

In some embodiments, perhaps after the WTRU has connected with the network A, the WTRU may report information to the mobility management entity of the network A. For example, the WTRU may send one or more of the WTRU location area information in the network B (e.g., LAI, RAI, TAI, etc), the identification/address of the mobility management entity for the WTRU in the network B (e.g., SS7 point code of MSC/VLR, SGSN_ID, GUMMEI, etc), and/or the WTRU identification in the network B (e.g., IMSI, S-TMTI, P-TMSI, GUTI, etc), and/or the like.

In some embodiments, perhaps if the mobility management entity of network A may have an interface to the indicated mobility management entity of network B and/or the two networks may support the inter-network paging over the interface, network A may indicate to the WTRU through NAS and/or RRC message that network A may support the paging from the other network (e.g., network B). In some embodiments, the WTRU may stop monitoring the other network while it may be connected to the network A.

In one or more embodiments, network A may inform network B via inter-network signaling that the WTRU may be active with network A, and/or may inform network B when the WTRU may become IDLE in network A. Network A may send to network B one or more of: the WTRU's identity in network A, the WTRU's identity in network B, and/or the ID of the WTRU's mobility management entity in network A.

In some embodiments, perhaps if network B may have a pending paging request for the WTRU and/or the WTRU may be active in network A, network B may forward the paging request to network A via the inter-network signaling. The original paging request may be included in a “container” IE, perhaps as a part of the inter-network message, and/or a heretofore undefined format inter-network paging message. In some embodiments, network B may send one or more of: the WTRU's identity in network A, the ID of the WTRU's mobility management entity in network B, and/or the priority of the paging request to network A, for example.

In some embodiments, perhaps upon receiving the inter-network signaling of the paging request, among other reasons, network A may identify the desired WTRU via the provided WTRU identification from network B, and/or may send a paging notification from the other network (e.g., forward the container provided by network B) to the WTRU. The paging notification may be included in one or more of: a NAS message, a RRC message, and/or in the user plane (e.g. the MAC Control Element in the downlink MAC PDU), and/or the like.

In some embodiments, perhaps upon receiving the paging request of network B via network A connection, among other reasons, the WTRU may send a paging response, for example based on preconfigured settings. For example, the WTRU may be configured such that network B may have a higher priority and therefore the WTRU may determine to respond to network B paging, perhaps even if in an active session with network A). For example, an indication may be presented to the user, and the user may indicate whether to respond or not. If a paging response is to be sent, there may be one or more ways the WTRU can respond to the page.

For example, the paging response may be sent to the network A via one or more of an NAS message, an RRC message, and/or user plane data. Network A may forward the paging response to the network B via the inter-network interface. The WTRU may disconnect from the network A and may start accessing network B. During the initial connection set-up messaging (e.g. RRC_CONNECTION_SETUP_REQUEST), the WTRU may indicate to network B that the paging response may have already been sent. In another example, perhaps upon receiving the indication of a page in network B via network A, the WTRU may disconnect (e.g., immediately) from the network A and may start to access network B, perhaps in order to send the paging response message, among other reasons, for example.

In some embodiments, the mobility entity of network B may start a timer waiting for paging response, perhaps after it may have sent the paging request through the inter-network interface (e.g., via network A). In some embodiments, perhaps if the mobility management entity of network B may not receive the paging response from the inter-network interface and/or from the network B air interface by the time the timer expires, the paging may be considered failed.

In some embodiments, perhaps if network B may wish to stop sending paging messages to the WTRU via network A, among other reasons, network B may inform the network A that it may not be sending the paging request through the inter-network interface (e.g., may not be sending the paging request any longer). In such scenarios, the network A may inform the affected WTRU of the change, perhaps so the WTRU can begin to monitor the network B paging channel again.

In one or more embodiments, techniques for informing the WTRU of notifications from a different network may include utilizing IMS techniques that may involve utilizing multiple Session Initiation Protocol (SIP) registrations from one or more different networks. For example, a WTRU with multiple SIM-cards may have multiple public Internet Protocol (IP)-Multimedia Subsystem (IMS) User identifiers with one or more public IMS User identifier associated with one SIM-card. As an example, a WTRU may have two SIM cards, and one may be associated with AAA with MSISDN number 111-11-1111 and another may be associated with BBB with MSISDN number 222-22-2222. The WTRU may have two public IMS User identifiers mapped to these two SIM cards, for example:

111-11-1111@aaa.com←→44111-11-1111

222-22-2222@bbb.com←→44 222-22-2222.

The WTRU may first attach to operator AAA's network and may be associated with IP address 10.10.10.2, for example. Then, for example, the WTRU may attach to operator BBB's network with IP address 100.100.100.4.

In some embodiments, it may be assumed that the WTRU may be in connected mode through operator AAA. Perhaps when another party (e.g., 333-33-3333@ccc.com) may attempt to connect to the WTRU via the phone number of the operator 2, the party may send an Invite message with the user's public ID (e.g., 222-22-2222@bbb.com) associated with the operator BBB. The WTRU may receive the Invite from 333-33-3333@ccc.com using its public ID associated with operator BBB. Perhaps if the user of the WTRU may decide to answer the Invite, among other reasons, the WTRU may release the connection with operator AAA and/or may use a service request procedure to establish an active connection to operator BBB. The WTRU may then update its registration with the IMS system with its new (e.g., fresh or updated) IP address (100.100.100.4). In some embodiments, it may select a new (e.g., fresh or updated) proxy call session control function (P-CSCF) during the registration update procedure. In some embodiments, the WTRU may send a 200OK message to the caller.

In one or more embodiments, IMS registration may support the use of multiple public IDs and/or may associate multiple public IDs with at least one physical IP address. For example, a WTRU may acquire and/or receive from a first network system information for cells in another network. For example, when the WTRU may switch to a new (e.g., fresh or updated) network, the 200OK message may be routed in a different route than the route in which the invite message may have been received. Embodiments contemplate one or more techniques that may update the route for the response.

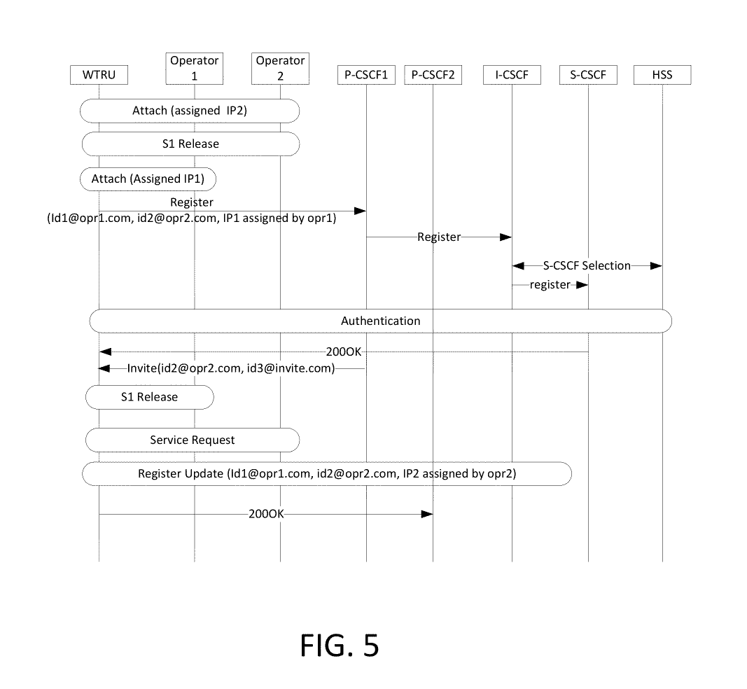

FIG. 5 illustrates an example signaling diagram for a WTRU to utilize multiple SIP registrations for different networks. In one or more embodiments, perhaps if the WTRU may be in an active session with network A and/or may receive a page from the other network B, among other reasons, the WTRU may release the current connection with network A. The WTRU may respond to the paging via network B and/or set up the connection with the other network B. For example, the WTRU can respond to the page and/or set-up a connection with network B, perhaps in some embodiments without notifying network A. In some embodiments network A may detect that the WTRU may no longer be available and/or may release the resources served for the WTRU.

One or more embodiments contemplate that, perhaps if there may be no predefined priority among the networks, among other reasons, the WTRU may present an indication to an end-user upon receiving a page from the other network. In some embodiments, the end-user may decide whether to respond to it or not.

In one or more embodiments contemplate, perhaps for a multi-SIM WTRU in multi-Standby mode in a cell/RAN/paging AREA that may utilize network sharing, among other scenarios, collapsing multiple sets of paging occasions into a single set of paging occasions. In some embodiments, an aggregation of multiple sets of paging occasions (e.g., from multiple networks) may be referred to as a “single occasion” herein for purposes of example and explanation and not by way of limitation. In some embodiments, the WTRU paging occasions (e.g., paging frames and/or paging subframes) may be WTRU-ID dependent. In some embodiments, perhaps if the multi-Standby mode multi-SIM WTRU (e.g., with more than one IMSIs) may use a single WTRU-ID for paging monitoring, among other scenarios, then multiple sets of paging occasions may be collapsed into a single occasion. In an example operator virtualization scenario, the WTRU may lack a UICC and/or may lack a permanent IMSI, so the paging procedure may be implemented using other parameters to determine the paging occasions. For example, some other type of parameter may be used by the WTRU to determine a paging occasion. The parameter may be one or more of: unique to the WTRU, unique to a particular network, shared among multiple networks, and/or derived based on parameters unique to the WTRU.

In some embodiments, the WTRU may use an existing IMSI (e.g., a single existing IMSI) for paging occasion determinations for one or more, or each, network to which it may connect. For example, perhaps in order to select a single IMSI from several Standby mode IMSIs as a WTRU-ID (e.g., a single WTRU-ID) for paging occasion determinations, one or more of the following techniques may be used by the WTRU and/or the network (e.g., RAN in MOCN or GWCN). In some embodiments, the WTRU may select the IMSI to use based on a comparison of the DRX-cycle length for one or more, or each, of the networks. For example, the WTRU may use the IMSI with the smallest/shortest DRX-cycle-length (e.g., the IMSI that may be associated with the smallest T value in the paging formula specified in §7.1 of 3GPP TS36.304, V10.5.0, E-UTRA User Equipment (UE) procedures in idle mode).

In some embodiments, the WTRU may select the IMSI to use based on a standby order. For example, the WTRU may use the IMSI that may be used for Idle mode paging in the cell/RAN/paging AREA for that particular multi-SIM multi-Standby WTRU, for example among the several IMSIs in Standby mode. For example, a multi-SIM WTRU with IMSI-1, IMSI-2, and IMSI-3 in a shared RAN with IMSI-2 may enter Idle mode stand-by for paging (e.g., and may use IMSI-2 since it may be associated with the RAN). IMSI-1 may roam into the RAN/cell and then IMSI-3 may enter Idle mode from connected mode. The WTRU may use IMSI-2 for calculating paging occasions for one or more IMSIs, or all 3 IMSIs. In some embodiments, perhaps if later IMSI-2 may get paged and may go to connected mode, among other reasons, IMSI-1 may be used for paging occasion determinations.

In some embodiments, the WTRU may select the IMSI to use based on a numerical value. For example, the WTRU may determine to use the IMSI that has the largest numerical value or the smallest numerical value.

In some embodiments, the WTRU may select the IMSI to use based on a network assignment. For example, the network (e.g., RAN in MOCN or the GWCN) may select one IMSI from several IMSI of the multi-SIM multi-Standby WTRU and/or may inform the WTRU about the assignment. The network may select the IMSI based on one or more of the techniques described herein.

In some embodiments, one or more of the aforementioned techniques may be adopted as the default method for preparing the “single occasion” paging procedure (e.g. perhaps if the IMSI may be selected based on a standby order, then the network and/or the WTRU may not specifically communicate regarding using the first IMSI for calculate the paging occasions).

In some embodiments, a paging occasion may be used that may be based on a unique ID that may be determined based on coordination between the RAN(s) and/or CN(s) of the various networks. For example, the network (e.g., RAN in MOCN or GWCN) may determine a “Paging-Occasion-Id” value for the multi-SIM multi-Standby WTRU that may be used by the WTRU to determine the paging occasions.

In some embodiments, the “Paging-Occasion-Id” value (or any other value such as an IMSI for a WTRU) may be selected such that the total system (cell/RAN) paging occasion load could be more evenly distributed. For example, if current paging frame load distribution (e.g., based on SFN mod T=(T div N)*(UE_ID mod N)—see 3GPP TS36.304, V10.5.0, E-UTRA User Equipment (UE) procedures in idle mode) may be weighted more towards and/or heavily towards the paging frame occasions resulted in (UE_ID mod N)=0, 1, 2, . . . <assuming N=4>, then a fresh or updated “Paging-Occasion-Id” value may be chosen such that Paging-Occasion-Id mod N=3, which may result in paging frames for the WTRU to be distributed in the frames of SFN mod T=(T div N)*3, perhaps to balance the system paging load. In one or more embodiments, a WTRU may be a user equipment (UE) and vice-versa.

A similar principle may be applied in some embodiments to the paging subframe occasion formula i_s=floor(UE_ID/N) mod Ns, such that the value chosen for Paging-Occasion-Id in i_s=floor(Paging-Occasion-Id/N) mod Ns may result in the selection of subframe(s) that currently not be heavily loaded.

In some embodiments, the network may open up new (e.g., updated or fresh) Paging Occasions for indicating to the multi-SIM multi-Standby WTRUs the presence of MT Calls. For example, new (e.g., updated or fresh) paging occasions may be introduced to accommodate the paging message sent to multi-SIM multi-Standby WTRUs, perhaps so that higher the increased paging load that may be caused by the pages to multi-standby WTRUs may be configured without disturbing the paging transmissions to regular (e.g., single SIM) WTRUs. An example of the contemplated time domain locations for the multi-Standby WTRU paging may be expressed as:

PF_Offset=(SFN mod T)−(T div N)*(UE_{—}ID mod N)

PSF_Offset=floor(UE_{—}ID/N)mod 10 and PSF_Offset≠[0,4,5,9]

Embodiments contemplate that the previously described collapsing multiple sets of paging occasions into a single set of paging occasions may still apply.

Embodiments contemplate one or more Multi-SIM multi-Standby WTRU techniques for Single Paging Occasion Monitoring and Reception. For example, a multi-SIM multi-Standby WTRU may use a single chosen IMSI, an assigned Paging-Occasion-Id, and/or an assigned single IMSI as the WTRU-ID to one or more of: determine the paging occasions, monitor for pages using the P-RNTI, and/or acquire the paging message if transmitted. The multi-SIM multi-Standby WTRU may then use one or more, or each, of the standing-by IMSIs to compare against the IMSI inside one or more, or each, of the PagingRecords in that paging message to determine whether there may be a MT call for it and/or what/who may be the paging source network(s). The network may send multiple PagingRecords (e.g., one for each active-SIM IMSI) to the same multi-SIM multi-Standby WTRU in a paging message (e.g., a single paging message) on a paging occasion (e.g., a single paging occasion).

In some embodiments, the WTRU may interact with the network in order to configure and/or trigger single occasion paging. For example, a multi-SIM multi-Standby WTRU may internally correlate one or more, or all, of the active-SIMs with a unique identifier (e.g., a correlation-Id) for the associating the multiple IMSIs and/or the WTRU to the PLMNs it may eventually register with, get service from, and/or roam into. This identifier may be in the SIM(s) from the WTRU manufacturer, service providers, and/or network operators. The correlation-ID may be a network recognizable identifier.

In some embodiments, perhaps when the WTRU may communicate with any of the networks it registers with/connects to/interact with, this correlation-Id may be transmitted along with its WTRU-Id (e.g., also referred to as a WTRU ID), such as the IMSI, to indicate/confirm the multi-SIM/ISM association of the WTRU. For example, the WTRU may inform the network of the correlation-Id in one or more of the following scenarios: when the WTRU may be connecting to a RAN, when the WTRU may be releasing a connection from a RAN, and/or when the WTRU may be AREA updating with the CN. The network entities (e.g., RAN to RAN, RAN to MME, MME to MME, etc.) may inform each other of the action by the WTRU (e.g., indicate the WTRU's IMSI, Correlation-Id, current State, network-affiliation, etc.), when a multi-SIM multi-Standby WTRU may be moving around and/or crossing CN/RAN boundary, and/or crossing paging AREA boundary, etc. The network entities may also send the correlation-ID to the multi-Standby WTRU in an assignment and/or in confirmation in downlink messages such as the RRC-Connection-Setup, RRC-Connection-Reconfiguration, Tracking-Area-Update-Confirm, and/or Attach-Accept, and/or the like messages.

In some embodiments, perhaps when the RAN may have learned that a particular multi-SIM multi-Standby WTRU may have more than one IMSI standing by for MT calls, the RAN may start the “single occasion” procedure. In some embodiments, the RAN may either rely on the default rules and/or one or more of the explicit rules described herein to select the IMSI or the Paging-Occasion-Id for the “single occasion” determination.

In some embodiments, the RAN may communicate an indication of the single occasion to the multi-Standby WTRU (e.g., if a default method may not be used) via a dedicated message such as an RRC-Connection-Release, a Tracking-Area-Update-Confirm, and/or Attach-Accept message. The RAN may use a paging message to signal the subsequent “single occasion” action to the WTRU.

In some embodiments, perhaps if the multi-Standby WTRU may not have entered into the “single occasion” paging monitor mode, the WTRU may monitor paging signals on one or more, or all, sets of paging occasions with its multiple IMSIs. If the multi-Standby WTRU enters the “single occasion” paging monitoring mode, for example after receiving the “single occasion” signal, among other scenarios, the WTRU may monitor the one set of paging occasions calculated from the selected/assigned IMSI or Paging-Occasion-Id.

In some embodiments, the RAN may notify the WTRU of which IMSI or Paging-Occasion-Id the subsequent “single occasion” paging may utilize so that the WTRU may make paging occasion determinations based on the selected identifier.

In some embodiments, perhaps in scenarios in which the multi-Standby WTRU's IMSI, on which the ongoing “single occasion” calculation may be based may have detached from the registered network (e.g., powered off), the other remaining active-SIM IMSIs may still be monitored by the WTRU. In some embodiments, a new (e.g., fresh or updated) “single occasion” IMSI or Paging-occasion-Id may be transmitted by the network to the WTRU via Detach-accept or RRC-Connection-Release messages.

An example of a paging message change is shown below in Table 1.

TABLE 1
Example Paging Message Change

| | |
|---|---|
| PagingRecord ::= | SEQUENCE { |
| ue-Identity | PagingUE-Identity, |
| cn-Domain | ENUMERATED {ps, cs}, |
| single-paging-occasion-id | IMSI or Paging-Occasion-Id chosen |
| ... | |
| } | |
| PagingUE-Identity ::= | CHOICE { |
| s-TMSI | S-TMSI, |
| imsi | IMSI, |
| ... | |
| } | |

In some embodiments, perhaps if the new value (e.g., the identifier used to determine when the single occasion paging occasions are going to occur) may be chosen from IMSIs, then the indication which IMSI to use may be transmitted, for example, in the form of an index of the IMSI that may be used by the WTRU for calculating the “single occasion” paging frames/subframes. For example, the IMSIs may be sorted in ascending or descending order or to the IMSIs according to their multi-SIM's activation and/or network registration order. In some embodiments, the index may be based on the relative order of the IMSIs.

In some embodiments, a temporary IMSI may be assigned to a WTRU, for example so that an operator agnostic network access capable WTRU may determine paging occasions even if it may lack a permanent and/or dedicated IMSI. For example, for operator agnostic network access capable WTRUs (e.g., WTRUs capable of operating in networks where operators may be virtualized, Operator Agnostic network access Device (OADs), etc.), the openID providers, the financial institutions, a service broker, other 3rd party stakeholders, other trusted entities, any other functions that may be defined in the virtualization layer (e.g., the virtualization layer of FIG. 2), and/or network elements of the virtualization layer may assign a temporary IMSI to the WTRU. For example, the entity that may assign the temporary IMSI may insert or communicate the assigned IMSI to the HLR/HSS and/or the mobility management entities of the supporting mobile networks that the WTRU may be attempting to access.

In some embodiments, the VSS (virtualized layer Subscriber Server), the VNMF (virtualized layer network manager function), and/or any other entity or node that may operate at the virtualization layer (e.g., open ID provider, financial institutions, etc.) may communicate to the HLR/HSS of the supporting mobile network(s) that the WTRU may desire to access the network and/or may indicate a temporary IMSI in the communication. The communication of the IMSI between the virtualization layer and/or the underlying mobile networks may occur at one or more of: the time of network registration by the WTRU, at service registration by the WTRU, and/or periodically upon expiration of a configurable timer. In an example, the communication of the temporary IMSI to the mobile network may occur at any point in time upon the initiation/request by entities within the virtualization layer (e.g., VSS, VNMF, and/or any other network element or node implementing the virtualization layer functions, such as openID providers, financial institutions, etc.). In an example, the IMSI may be communicated to the mobile network upon a request from the supporting mobile networks (e.g., MME or SGSN or HSS or HLR).

In some embodiments, the assignors of the temporary IMSI may be the functional entities of the virtualization layer and/or network elements implementing the virtualization functions. The nodes or entities that may be responsible for assigning a temporary IMSI to the WTRU may be configured to assign the temporary IMSI, perhaps when the mobile network may attempt to authenticate the user of the WTRU with the virtualization layer. The assigned IMSI may be forwarded to the WTRU through the mobile network supporting the virtualization network. In an example, the WTRU may be provisioned with the temporary IMSI by a stakeholder that may be operating at the virtualization layer (e.g., through the virtualization layer functions, network elements, and/or servers), for example using Open Mobile Alliance (OMA) over-the-air (OTA) device management (DM), and/or a like mechanism. The WTRU may be provisioned with the temporary IMSI by a stakeholder operating at the virtualization layer, for example through a wired interface (e.g., wire internet connection). In an example, the WTRU may be provisioned with the temporary IMSI by a stakeholder that may be operating at the virtualization layer directly from one or more of: the WTRU terminal, through another device or application hardwired to the WTRU, and/or through another device or application connected wirelessly to the WTRU (e.g., Bluetooth, NFC, etc.).

In some embodiments, perhaps if the mobile network entity that interacts with the virtualization layer (e.g., openID providers, the financial institutions, service broker, other 3rd party stakeholders, trusted entities and/or any of the functions defined in the virtualization layer of the FIG. 2, and/or the like) may be aware of the IMSI that may have been assigned to the WTRU, this interacting entity may indicate (e.g., by sending) the temporary IMSI into the HSS/HLR and/or the mobility management entities. In some embodiments, perhaps if the assigned IMSI may be transferred directly to the WTRU and/or the interacting entity (e.g., the operator network providing the access to centralized resources) may be unaware of the identity of the temporary ISMI that may be assigned to the WTRU, among other reasons, then the temporary IMSI may be indicated (e.g., by inserting or sending the IMSI) into the HSS/HLR and/or the mobility management entities. For example, the assignor may send a message to the HSS/HLR (and/or some other node in the access network) via an interface between assignor and the operator network (e.g., Diameter). In an example, the assignor may indicate and/or communicate the IMSI data to the mobile network from which the authentication may have been initiated and/or to other mobile networks that WTRU may access and/or monitor for paging.

In an example, the IMSI assignor may have a pool of temporary IMSIs. The IMSI pool may be assigned and/or shared among the stake holders of the virtualization layers (e.g., openID providers, financial institutions, service brokers, etc.), for example perhaps in order to prevent overlapping, among other reasons. For example, one or more, or each, of the various stake holders in the virtualization layer may be associated with a unique ID, and the unique ID may be part of the temporary IMSI construct, perhaps in order to ensure uniqueness between virtualization stakeholders, among other reasons. In such scenarios, a portion of the temporary IMSI may be unique to one or more, or each, assigning entity, perhaps so as long as one or more, or each assigning entity may be ensured that it did not provide a duplicate IMSI to any two WTRUs. In such scenarios, the uniqueness may be maintained between one or more, or all, of the entities in the virtualization layer.

In some embodiments, the supporting mobile networks for the virtualization network may provide a local mapping between the IMSI (and/or the like) allocated by the virtualization layer and/or the IMSI that may be communicated to the WTRU, perhaps in order to ensure the uniqueness of the temporary IMSIs issued to a WTRU, among other reasons. For example, the supporting mobile network (e.g., the network providing radio access to the WTRU) may insert into the IMSI received from the virtualization layer an identity that may be unique to the supporting mobile network. The temporary IMSI, or the like, may also be assigned to the WTRU, perhaps as part of a coordination between the virtualization layer and/or the supporting operator's networks (e.g., mobile network) and/or the generation of the IMSI.

In some embodiments, perhaps when a temporary IMSI may be assigned, a “lifetime” value may also be specified by the assignor. The lifetime value may be indicated to the WTRU and/or the mobile network entities. In some embodiments, the lifetime value may define the length of time for which the temporary IMSI may be valid. Perhaps after the lifetime may expire, among other scenarios, the IMSI may be considered invalid and/or may be recollected by the assignor for assignment to other WTRUs, for example.

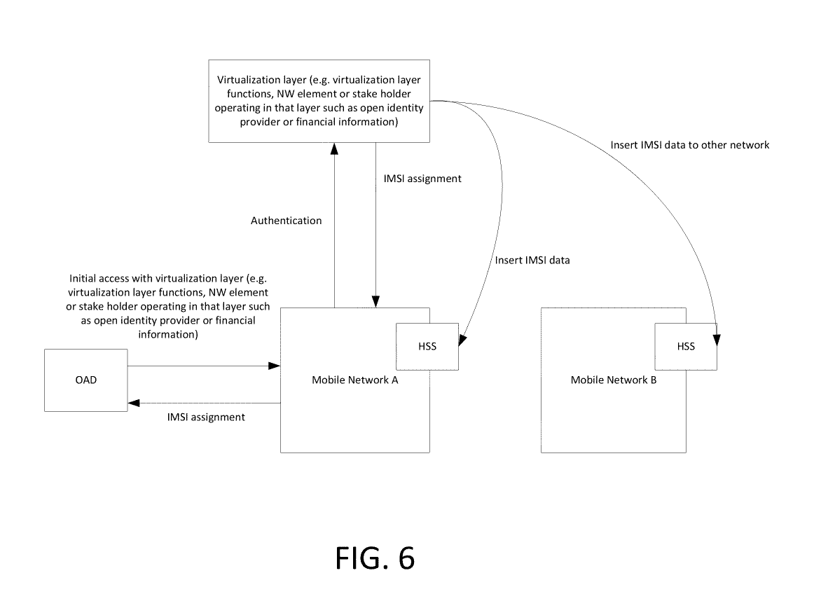

FIG. 6 illustrates an example technique of temporary IMSI assignment by a virtualization layer. For example, an operator agnostic network access capable devices (OAD) (e.g., WTRU) may access Mobile Network A, perhaps in order to obtain services for a virtualization layer. During the initial access with the virtualization, authentication with the virtualization layer may be performed. Perhaps after the WTRU may successfully authenticate with the authentication layer, among other scenarios, the virtualization layer may assign an IMSI to the WTRU. The virtualization layer entity/function may send an indication of the IMSI and/or the IMSI itself to one or more Mobile Network A nodes such as the Home Subscriber Server (HSS) and/or to Mobile Network B, which may be another mobile network accessed by the OAD, perhaps in order to communicate with the virtualization layer. In some embodiments, Mobile Network A may indicate the IMSI to the OAD.

In some embodiments, the mobile network may assign a temporary IMSI to the WTRU, for example the first time the WTRU may access and/or attach to the mobile network. In some embodiments, the WTRU may attach to multiple mobile networks at the same time and/or may have different temporary IMSIs from different mobile networks. In some embodiments, the first network may assign a temporary IMSI and may send the IMSI data to other mobile networks that the WTRU may access. In such scenarios, the WTRU may utilize a single common temporary IMSI for each of the mobile networks.

In some embodiments, the mobile networks may maintain a pool of temporary IMSIs. Perhaps when a temporary IMSI may be assigned by a mobile network, among other scenarios, a “lifetime” value may also be specified by the mobile network. The lifetime value may be indicated to the WTRU and/or the virtualization layer. The lifetime value may define the length of time for which the temporary IMSI may be valid. After the lifetime may expire, the IMSI may be considered invalid and/or may be recollected by the mobile network for assignment to other WTRUs.

In some embodiments, the term “temporary IMSI” may be used to describe example techniques utilized by the virtualization network. One or more embodiments contemplate examples described in terms of a temporary IMSI that may be equally applicable to cases utilizing a permanent IMSI. Therefore, one or more of the examples of processing performed using the temporary IMSI may be equally applicable to scenarios where the WTRU may use a permanent IMSI.

One or more of the techniques and systems described herein may be equally applicable to scenarios where another identity rather than, or in addition to, the IMSI may be assigned to the WTRU by the virtualization layer. For example, in some embodiments, rather than allocating a temporary IMSI, the virtualization layer may allocate one or more other identifiers to the WTRU and/or may coordinate with the mobile network for the mobile network to allocate the one or more other identifier (e.g., other unique identifier). In some embodiments, such an identity may be a unique service identity for service association between the user and the virtualization layer stakeholder(s). For example, in the context of virtualization (e.g., virtualization by way of operator agnostic network access), where the user may lack a subscription to a given mobile operator and/or any subscription at all (e.g., including subscription to a virtualization layer stake holder) the IMSI, perhaps instead of being interpreted as the “international mobile subscriber identity”, may be interpreted as the “international mobile service association or service binding identity.”

In some embodiments, an IPv6 address of the WTRU may be used for determining the location/timing of paging occasions for the WTRU. For example, for operator agnostic network access capable WTRUs (or OADs—operator agnostic network access capable devices), perhaps if the WTRU may have an IPv6 address assigned, among other scenarios, the IPv6 address may be used for a paging occasion calculation.

Embodiments contemplate one or more techniques for using an IPv6 address for a paging occasion determination. For example, the WTRU may treat the 128 bit IPv6 address as the BCD (Binary Coded Decimal) encoding (e.g., the result of BCD encoding) of a sequence of 32 digits of type Integer (0 . . . 9). In this example, the BCD encoding may be assumed to be based on 4 bit encoding. The 32 digit integer number derived from the 128 BCD bits may be used the same way as the 15 digit IMSI integer value may be used in the paging occasion calculation formulas. For example, UE_ID=(IPv6 address as 32 digits integer number) mod 1024.

In an example, the IPv6 address as 128 bits binary digit can be used directly in the calculation of the UE_ID: UE_ID=(IPv6 address in 128 bit format) mod 1024.

Embodiments contemplate a WTRU identity type “IPv6 address” for the WTRU paging identity that may be included in the paging record. Perhaps to reduce the paging overhead, among other reasons, a truncated IPv6 address (e.g., the last 32 or 64 bits of the address) may be used as the paging WTRU identity.

In some embodiments, the IPv6 address may be transformed into some IMSI-like 15 digit decimal number. For example, in a 4 bit BCD based encoding scheme, the last 60 bits of the 128-bit address may be used. In another example, the last 60 bits of the 64 even or odd bits of the 128-bit address may be used as “IMSI”. In an example, the 60 bits may be selected alternatively throughout the 128 bit IPv6 address. For example, 8 bits may be ignored leading to 120 bits, and/or 60 bits may be selected alternatively throughout the 102 bits, and/or the 60 bits may be converted into an IMSI-like 15 digit integer number, perhaps assuming a 4 bit BCD based encoding scheme. For example, the ignored bits may be the least significant bits.

In some embodiments, BCD schemes greater or less than 4 bits may be used. For example, the 128 BCD bits IPv6 address may also be converted using an 8 bit encoding based BCD scheme or any other “fixed number of bits” based BCD encoding scheme. In the example of 8 bits encoding based scheme, the IPv6 address may be converted into a 16 digit integer number.

In some embodiments, other identities may be used for the paging occasion determination. For example, even if the WTRU operating to access a virtualized network may lack an IMSI and/or SIM-like UICC, the WTRU may have a globally unique identifier (GUID). The GUID may be used by other parties to identify the WTRU and/or by WTRU to identify itself. The GUID may be provided by MNO or other parties, (e.g., service providers such Google, Yahoo, amazon, etc.).

In some embodiments, the GUID may be in the form of a number or a string. To calculate the paging occasion using GUID, embodiments contemplate techniques to convert the GUID to a pseudo-IMSI like number (e.g., a 15 digit decimal number). In some embodiments, the GUID may be converted to a pseudo-IMSI like number. One or more common characters from the GUID string may be identified and/or removed. For example, a user may have a GUID such as KingJulien1988@gmail.com. The system (e.g., the mobile network node or virtualization layer node) may be configured to remove the common characters such as “@” and “.com” from the GUID string, for example. The system (e.g., the mobile network node or virtualization layer node) may be configured to interleave the remaining characters, for example to make it more random. The system (e.g., the mobile network node or virtualization layer node) may convert one or more, or each, character into a multi-digit number. The system (e.g., the mobile network node or virtualization layer node) may be configured to interleave the digits after the conversion. The system (e.g., the mobile network node or virtualization layer node) may then remove digits in order to generate a 15 digit pseudo-IMSI number. In an example, the system (e.g., the mobile network node or virtualization layer node) may XOR the digits to generate 15 digits pseudo-IMSI number. The pseudo-IMSI number may be used by systems and/or WTRUs for paging occasion determinations (e.g., using paging occasion calculation equations).

In one or more network/operator virtualization scenarios, the WTRU may lack a link to any specific mobile network. The incoming calls/messages for the WTRU could be delivered through a number of different networks that may be available. In some embodiments, the WTRU in a virtualization scenario may monitor the paging on multiple networks, for example in a similar manner as is described herein for a multi-SIM WTRU. For some multi-SIM WTRU embodiments, the loaded SIM cards may dictate which networks to monitor. For some WTRU in virtualization scenario embodiments, the WTRU may utilize additional techniques or information in order to determine which networks to monitor.

In some embodiments, the openID provider, the financial institution, and/or other stakeholders of the virtualization layer may provide the WTRU with a list of networks that the WTRU may (or in some embodiments perhaps should) monitor for paging. The openID provider, the financial institution, and/or other stakeholders of the virtualization layer may create such a list based on one or more of the following pieces of information, in any combination. For example, the openID provider, the financial institution, and/or other stakeholders of the virtualization layer may create the list of networks that the WTRU may monitor for paging based on one or more of: a preferred network list include in the user profile data, rate information of the potential networks, service agreements between the stakeholder and the network operators, user location reported by the WTRU, the detected networks reported by the WTRU, and/or the WTRU capabilities reported by the WTRU, and/or the like.

In some embodiments, a WTRU may provide information such as WTRU capabilities, WTRU location, and/or WTRU preferences, and/or the like, perhaps when it may register with the stakeholder. Perhaps after the user may be authenticated, among other scenarios, the stakeholder may return the list of networks to monitor, for example, among other results. In some embodiments, priorities may be defined for the networks that maybe included in the list. Perhaps when the WTRU may detect that some network that may be included on the list may no longer be available, among other reasons, the WTRU may inform the stakeholder and/or the network virtualization layer that the network may be no longer available. By doing so, an incoming call might not be delivered through that network.

Embodiments contemplate coordinated paging and/or network access in RAN sharing and/or roaming scenarios. Accessing both operators' network via the same host network may greatly reduce the complexity of the dual-SIM WTRU and/or may reduce the WTRU power consumption. Embodiments recognize that most major operators today may have roaming agreements. Embodiments contemplate that optimizing the dual-SIM WTRU performance to access both operators' network via the same host network may reduce the dual-SIM WTRU's impact on the current network and/or may reduce dual-SIM WTRU's power consumption.

For example, it may be a waste of resources for the dual-SIM WTRU to camp separately on different cells belonging to its operators' network and/or monitor cells from both operators' network to maintain reachability. Since a WTRU may perform cell selection/reselection independently for one or more, or each, of its SIM-Card associated operator networks, the power consumption of the dual-SIM WTRUs may be increased compared to the single SIM-Card WTRUs. If the dual-SIM WTRU may camp on a single cell and may register to the two operator's networks, for example one as the host public land mobile network (PLMN) and another as roaming WTRU and/or both as roaming WTRU, the WTRU may monitor neighbor cells in the host operator and/or might not for the non-host operator, which may reduce the power consumption.

In some embodiments, perhaps to enable the Dual-SIM WTRU camping on the same RAN node, among other reasons, contemplated cell selection criteria may be implemented in the Dual-SIM WTRU. Contemplated cell search techniques may include one or more of the following. For example, the Dual-SIM WTRU may have two separated NAS stacks (e.g., one for each network) and may initiate cell search independently for one or more, or each, of its operator's networks. In some embodiments, perhaps once the cell search may find a cell that may be allowed by both operators' networks, the Dual-SIM WTRU may stop the cell search in the other network.

In some embodiments, the Dual-SIM WTRU may have two separated NAS stacks (e.g., one for each network), and the Dual-SIM WTRU may have interaction between the NAS stacks and/or its different operator network. In such scenarios, the WTRU may utilize a single cell search that may be applicable to both operator networks. For example, the Dual-SIM WTRU may prioritize its two SIM-CARDs (e.g., one may be primary network operator and another may be secondary operator). The Dual-SIM WTRU may trigger the cell search for its primary network operator. In some embodiments, perhaps before the Dual-SIM WTRU may trigger the cell search, among other scenarios, the NAS associated with its primary SIM may request information from the other secondary SIM-CARD(s).

In some embodiments, the Dual-SIM WTRU may trigger cell search for a host network that may be the home network or one of the equivalent home networks of the Dual-SIM WTRU's primary operator network. The WTRU may also determine whether the host network may also be the home network or one of the equivalent home networks of the Dual-SIM WTRU's secondary operator network. Perhaps if so, among other reasons, the WTRU may select the host network.

In some embodiments, the Dual-SIM WTRU may trigger cell search for a host network that may be the home network or one of the equivalent home networks of the Dual-SIM WTRU's primary operator network. The WTRU may also determine whether the host network might not be in the forbidden PLMN list of the Dual-SIM WTRU's secondary SIM-CARD. Perhaps if so, among other reasons, the WTRU may select the host network.

In some embodiments, the Dual-SIM WTRU may trigger cell search for a host network that might not be in the forbidden PLMN list of both Dual-SIM WTRU's SIM-CARDs.

In some embodiments, perhaps once the Dual-SIM WTRU may have found a suitable cell belonging to a host network that may be allowed by both its operator's networks, among other scenarios, the WTRU may register to both its operator networks via the same host network. For example, the Dual-SIM WTRU may include its IMEI (International Mobile Equipment Identity) in the ATTACH REQUEST message. The host network may link the two active S1 links for one or more, or each, of the Dual-SIM WTRU's NAS to the same equipment. The Dual-SIM WTRU may include other types of identifier(s) which may be used to link two active NAS context to at least one WTRU. The Dual-SIM WTRU may use other NAS or RRC messaging to link two active NAS contexts with the same WTRU. The message may include (but is not limited to) one or more of a WTRU capability Message, a TAU/RAU/LAU update, and/or a contemplated NAS message, and/or the like.

In some embodiments, perhaps if the Dual-SIM WTRU may be unable to locate a suitable cell in a host network that may be allowed by both its SIM-CARD(s) (e.g., operator's networks), the WTRU may trigger cell search independently for one or more, or each, of its SIM-CARD associated operator networks.

In some embodiments, in idle mode, perhaps if the Dual-SIM WTRU may camp on the same cell with respect to its two active NASs for one or more, or each, of its SIM-CARD associated operator networks, the WTRU may maintain a single active AS layer with cell re/selection procedure to maintain idle mode mobility. In some embodiments, perhaps since there may be a single AS layer active, the Dual-SIM WTRU may save on its power consumptions. In an example, with a single active AS layer, the Dual-SIM WTRU may perform reselection according to one or more of the following criteria. For example, the WTRU may rank the cell(s) whose PLMN may be the home PLMN of its primary and/or secondary operator network higher. The WTRU may rank the cell(s) whose PLMN may be the home PLMN of its primary operator network and/or equivalent PLMN of its secondary operator network next. The WTRU may rank the cell(s) whose PLMN may be the home PLMN of its primary operator network and might not be in the forbidden PLMN list of its secondary operator network next. The WTRU may rank the cell(s) whose PLMN may be in the home PLMN of its secondary operator network and/or equivalent PLMN of its primary operator network next. The WTRU may rank the cell whose PLMN might not be in the forbidden PLMN list of both its operator's network next. The WTRU may rank the cell(s) with any PLMN next. The order of the rankings may also be altered (e.g., The WTRU may rank the cell(s) whose PLMN may be in the home PLMN of its secondary operator network and equivalent PLMN of its primary operator network higher than the WTRU ranks the cell(s) whose PLMN may be the home PLMN of its primary operator network and might not be in the forbidden PLMN list of its secondary operator network, etc.)

Embodiments contemplate that the Dual-SIM WTRU may rank the target cell that may be allowed by both SIM-CARDs higher than the cell that may be allowed by a single f its SIM-CARDs. If the Dual-SIM WTRU cannot locate a cell that may be allowed by both its operator networks, the WTRU may activate AS for its secondary operator network and/or may perform reselection independently for one or more, or each, of its operator's networks.

In some embodiments, perhaps when a Dual-SIM WTRU may camp on the same cell on a host network, among other scenarios, the host network may treat it as at least two active WTRUs with at least two active MME contexts. Since the Dual-SIM WTRU may include a WTRU-ID (e.g., IMSI) associated with one or more, or each, of its operator networks, the WTRU may have different Paging Occasions (POs). When the host network may receive a paging request associated with the TMSI of at least one of the Dual-SIM WTRU's operator networks, the host network may deliver the paging the Dual-SIM WTRU on the PO corresponding to the IMSI that may be assigned by that operator network.

In some embodiments, the Dual-SIM WTRU may monitor two POs during one or more DRX cycles. To further save on the Dual-SIM WTRU's battery power, among other reasons, the following techniques could be implemented by network and/or Dual-SIM WTRU. For example, the network may inform the Dual-SIM WTRU of which PO it may wish the Dual-SIM WTRU to listen to. In an example, when Network may receive a paging request, if the host network may determine that the WTRU may have another active context in the network (e.g., based on IMEI or other equipment ID or by other ways), the host network may page the WTRU on one or both its POs. In an example, the Dual-SIM WTRU may listen to at least one of its POs, either as indicated by network or by its own preference.

In some embodiments, perhaps when one of the Dual-SIM WTRU contexts may be in the connected mode and another one may be in the idle mode, the WTRU may consider itself in the connected mode and/or may stop performing idle mode mobility procedures.

In some embodiments, perhaps if the Dual-SIM WTRU's idle mode WTRU context and connected WTRU context may be in different networks, the Dual-SIM WTRU's idle mode context may reselect to the serving cell of the Dual-SIM WTRU's connected mode context and may send a TAU to the host operator serving the WTRU's connected mode context. In the TAU message, the Dual-mode WTRU may indicate the relationships of the two WTRU contexts, for example by including the WTRU's IMEI or by other ways. In such scenarios, the host network may link two WTRU contexts to the same equipment.

In some embodiments, perhaps when Dual-SIM WTRU may be performing one or more connected mode procedures (e.g., handover, etc.), the network may (e.g., perhaps at the same time) relocate the WTRU's IDLE mode context. In some embodiments, a WTRU's IDLE Module B may try to follow Connected Module (A)'s mobility. Perhaps if Module A may be connected in network A, among other scenarios, Module B may try to register in the same network A as a roaming user, for example. In such scenarios, the serving cell of Module A may also be the serving cell of Module B, and it may have a connected context and/or an IDLE context for the same user. Perhaps if the connected context may be handed-over to another cell, among other scenarios, the new (e.g., different) serving cell may get the idle context from the old (e.g., previous) serving cell. In such scenarios, both WTRU contexts may be maintained as reachable.

In some embodiments, perhaps when the Dual-SIM WTRU may be in a connected mode with at least one of its WTRU contexts (for example referred to as a first WTRU context for explanatory purposes) and/or the other WTRU context (for example referred to as a second WTRU context for explanatory purposes) may be in IDLE mode and the host network may be aware of both WTRU contexts, the host network may receive a paging request for the Dual-SIM WTRUs idle mode context. The host network may determine that the idle mode WTRU context may be linked to a connected mode WTRU context. In such scenarios, the host network may determine not to page the WTRU associated with the idle mode WTRU context. Instead, perhaps if the paging request may be received from a CS domain and/or the WTRU may currently have an active CS call, the host network may trigger call waiting for the incoming call and/or may send an indication to the WTRU to inform a user about the incoming call. In some embodiments, the host network may use a heretofore undefined NAS message and/or a modified NAS message to deliver the indication to the user. The indication may include one or more of the incoming call's caller ID, the incoming call's target WTRU context/SIM-CARD, and/or the like.

In some embodiments, perhaps when the Dual-SIM WTRU may receive the indication, it may display the received information to a user and/or may give a user one or more of the following functions. For example, the WTRU may allow the user to choose to ignore the incoming call. The WTRU may allow the user to choose to terminate the current call and/or answer the page in the same host network with another WTRU context. The WTRU may allow the user to choose to terminate the current call and/or answer the page in the preferred host network that may be associated with a second WTRU context. The WTRU may allow the user to choose to answer the incoming call with the first WTRU context.

In some embodiments, a WTRU may re-read the system information on network B, perhaps after it becomes IDLE (e.g., again) after a session in network A, among other scenarios. In some embodiments, perhaps if the WTRU may receive the paging from network B while it may be in active session with network A, and/or the user may decide to respond to the paging, the WTRU may re-read the system information of network B, perhaps in some embodiments before it accesses it.

In some embodiments, network B may inform network A that the System Information has changed in the area where the WTRU may be. In some embodiments, network A may inform the WTRU of the system info change. The WTRU may re-read the system information, perhaps after it may become IDLE again if such a notification may have been received.

The WTRU may report to network A its location information in network B, and/or the ID/address of the WTRU's previous mobility management entity in network B. Network A may inform network B via inter-network signaling that the WTRU may be active with network A, and/or may inform the other network when the WTRU may become IDLE. Network A may include the WTRU's identification of network A and/or the other network B for network B to identify the WTRU in question.

In some embodiments, perhaps when there may be a system information change in network B, among other scenarios, the corresponding mobility management entity (MME, SGSN, MSC/VLR) may also be notified. Perhaps if the mobility management entity may determine that there may be a registered WTRU currently active in the other network A, among other scenarios, it may send a notification to network A that the system information may have changed for certain areas (e.g., the cell ID and/or the location/tracking area ID of the cell). In some embodiments, the concerned WTRUs ID could also be included. In some embodiments, perhaps when the system information of network A may have changed, a notification may be sent to network B where the WTRU may be connected, perhaps so the WTRU may know that it may be useful to update network A's system information. In some embodiments, the cell ID and/or area ID may be useful for network B and/or the WTRU to figure out whether the system information change may impact the WTRU (e.g., whether a system information update may be useful, or whether a system information update might not be sufficiently useful).

In some embodiments, perhaps upon receiving such a notification, among other scenarios, network A may compare the cell ID and/or the location/tracking area ID where the system information change may have happened, and may compare it with the WTRU's location information (e.g., perhaps as previously reported by the WTRU). If the network decides that the system information change may impact the WTRU, among other scenarios, it may send a notification to the WTRU via NAS and/or RRC signaling.

In some embodiments, perhaps upon receiving such a notification, the WTRU may refrain from switching (e.g., immediately switching) to network B to read the updated system information. In some embodiments, the WTRU may mark the change and/or may wait until it may become IDLE (e.g., become IDLE again) to read the updated system information on network B.

In some embodiments, network A and/or network B may exchange their system information parameters for the cells serving the WTRU. The active network may communicate to the WTRU the system information parameters of the network with which the WTRU might not be actively engaged in communication. The communication of the system information parameters of network B to the WTRU on network A can be achieved by network A by broadcasting network B system information and/or through a dedicated signaling to the WTRU (RRC message or NAS message).

In some embodiments, for example in scenarios of operator virtualization, the operator agnostic network access capable WTRU (e.g., OAD) may use less system information than a typical WTRU that may be camped on a cell and/or may determine to monitor system information in a manner different than a traditional WTRU. In some embodiments, the WTRU may obtain the SI relatively less often and/or may refrain from obtaining certain types of SI that might not be used. In some embodiments, the VNMF (Virtualization layer Network Manager Function) and/or any other functional entities of the virtualization layer (e.g., alone or in coordination with the VNMF) may store the up-to-date system information of the networks that may be under its management and/or which may potentially provide service to the WTRU. In some embodiments, perhaps after the WTRU may be registered/authenticated in the virtualization network, among other scenarios, the WTRU may download the system information from the VNMF, for example through the user plane data and/or the control plane. In some embodiments, the VNMF may be assumed to have the up-to-date system information of one or more, or multiple, networks.

In some embodiments, perhaps when the WTRU may request that the VNMF provide the system information, among other scenarios, the WTRU may indicate the network IDs that it may wish to access. The VNMF may send the corresponding system information to the WTRU.

The WTRU may download the system information of one or more, or multiple networks (e.g., at the same time) and/or it may download the system information of a specific network, perhaps before it may attempt to access that specific network, among other scenarios.

In some embodiments, perhaps for a given network, a part of and/or the entirety of the SI may be downloaded together (e.g., a copy of the MIB and one or more, or each, of the SIBs may be downloaded). In some embodiments, a subset of the information (e.g., the relevant portions of the SI) such as MIB, SIB1, and/or SIB2 may be downloaded. In some embodiments, the remaining SI may be downloaded, perhaps based on request of the WTRU as desired. In some embodiments, the WTRU may indicate which portion(s) of system information may request to download.

In some embodiments, perhaps when the system information in the VNMF may be updated, the VNMF may “push” the updated system information to the WTRU. The VNMF may send the WTRU an indication that the system information of certain networks may have changed, perhaps so that the WTRU may request to download the changed information, among other reasons. In some embodiments, the VNMF may transmit the updated system information to the WTRU, perhaps without receiving an explicit request to do so.

In some embodiments, perhaps when WTRU may request to download the updated system information and/or the VNMF may transmit the updated SI to the WTRU, the entire copy of the system information that may have the one or more changes may be downloaded by the WTRU. In some embodiments, the portion of the information that WTRU may have previously downloaded may be re-transmitted to the WTRU (including any changes). In some embodiments, a piece of the information that may have changed may be transmitted to the WTRU, perhaps in some embodiments while unchanged parameters may be omitted.

In some embodiments, perhaps while the WTRU may download the system information from the VNMF, it may read the system information broadcasted in the air interface, perhaps when desired, among other scenarios. The reading of broadcasted SI may occur if the WTRU may desire to compare the downloaded system information with the broadcasted SI to see if the downloaded version may be up-to-date, among other reasons. The WTRU may verify that the SI provided by the VNMF may be up-to-date by comparing the valueTags that may be included in the downloaded version and the tag that may be broadcasted. The WTRU may read the broadcasted SI when it may receive a paging indicating an SI modification notification and/or the WTRU may have not downloaded the new SI from the VNMF, perhaps so it may directly read the updated SI from the air interface, among other reasons. The WTRU may read the broadcasted SI in case of EWTS and/or another urgent SIB change (e.g., SIB for overload control), perhaps since the WTRU may be able to determine the update faster by reading the broadcasted SIB(s), for example.

In some embodiments, the communication networks (e.g., underlying mobile networks) that may support the virtualization layer may be organized in a cluster of networks (e.g., cluster of adjacent networks). One or more, or each, cluster may have an entity (e.g., network element) that may consolidate and/or distribute system information to WTRUs in the service area of the clustered network. The entity that may distribute the system information may be one or more of: an entity located in one of the supporting underlying operator networks (e.g., mobile network); may be located in the virtualization layer (e.g., network element of the virtualization network); and/or may be located in the cloud.

In some embodiments, the VNMF may use a distributed implementation of the system information storage. In such embodiments, the system information may be organized according to a distributed architecture that may be mapped to the underlying supporting mobile operator network clusters. The distribution of the system information may be through dedicated signaling (e.g., in control plane or user plane) and/or may be through broadcasting. The virtualization layer (e.g., VNMF, or any functional entities of this layer or any stakeholder of this layer) alone or in coordination with the supporting underlying network (e.g., mobile network) may communicate to the WTRU the representative list (e.g., representing clusters of networks) of the underlying networks (e.g., mobile network) and/or virtualization network entities to monitor, perhaps in order to receive the system information of the networks that may serve the WTRU. In some embodiments, the VNMF may distribute the list of networks that may be included in the cluster to the WTRU via one or more of the networks in the cluster. The list of networks in the cluster that may be used by the WTRU to access the virtualization layer may take into account one or more of: the preferred network list that may be in the user profile data; rate information of one or more, or each, network; the service agreement between the stakeholder and the network operators; the user location reported by the WTRU; the detected networks reported by the WTRU; the WTRU capabilities reported by the WTRU; and/or the like. In some embodiments, the list may include a priority.

Although one or more examples described herein may be described in terms of multi-SIM WTRUS (e.g., DSDS WTRUs), the examples may be equally applicable to WTRU using multiple access/mobile networks to utilize virtualized resources or services. Therefore, the concepts described herein should not be limited to specific example described. For example, techniques described for a DSDS WTRU may be used by a WTRU accessing virtualized services, or vice versa.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method for determining a set of paging occasions for a wireless transmit receive unit (WTRU) in communication with two or more communication networks, the method comprising:
determining a WTRU identifier (ID) for paging monitoring of a first communication network of the two or more communication networks and a second communication network of the two or more communication networks; and
determining the set of paging occasions based on the WTRU ID, one or more paging occasions of the set of paging occasions corresponding to at least one of the first communication network or the second communication network.

2. The method of claim 1, wherein the set of paging occasions is a single set and the WTRU ID is a single WTRU ID.

3. The method of claim 1, wherein the WTRU is an operator agnostic network access capable device (OAD).

4. The method of claim 1, further including determining a paging occasion schedule based on the WTRU ID.

5. The method of claim 1, wherein the WTRU ID is a temporary International Mobile Subscriber Identity (IMSI).

6. The WTRU as in claim 1, wherein the WTRU ID is determined based on an Internet Protocol (IP) version 6 (IPv6) address for the WTRU.

7. The WTRU as in claim 1, wherein the WTRU ID is determined based on a globally unique identifier (GUID) for the WTRU.

8. The method of claim 1, wherein the single WTRU ID is provided by an entity providing to the WTRU at least one of virtualized resources or virtualized services.

9. The method of claim 1, wherein the WTRU has a subscription with at least one of the first communication network or the second communication network, and the WTRU does not include a device configured with a subscriber identity module (SIM) function.

10. The method of claim 1, wherein the WTRU includes a device configured with a subscriber identity module (SIM) function, and the WTRU does not have a subscription with either the first communication network or the second communication network.

11. A method for determining a set of paging occasions for a wireless transmit receive unit (WTRU) in communication with two or more communication networks, the method comprising:
receiving by a first communication network of the two or more communication networks information related to a second communication network of the two or more communication networks;
determining the set of paging occasions by the first communication network based on the information, the set of paging occasions corresponding to the second communication network; and
sending by the first communication network the set of paging occasions to the WTRU.

12. The method of claim 11, wherein the information related to the second communication network is received from the WTRU.

13. The method of claim 11, wherein the information related to the second communication network includes one or more paging related parameters of the second communication network.

14. The method of claim 11, wherein the information related to the second communication network includes at least one of: a WTRU identification specific to the second communication network, an identification of the second communication network, a priority of the second communication network for the WTRU, a technology of the second communication network, a standard of the second communication network, a policy of the second communication network, or a timing difference between the second communication network and the first communication network.

15. A method performed by a transmit/receive unit (WTRU) in communication with two or more communication networks in an operator virtualized network environment, the method comprising:
registering with a virtualization layer management function of the operator virtualized network environment; and
obtaining system information from the virtualization layer management function, the system information regarding at least one of a first communication network of the two or more communication networks or a second communication network of the two or more communication networks.

16. The method of claim 15, wherein the WTRU is an operator agnostic network access capable device.

17. The method of claim 15, wherein the virtualization layer management function maintains current system information for the first communication network and the second communication network.

18. A method for obtaining system information from a communication network, the method comprising:
sending a first indication from a first communication network to a second communication network, the first indication indicating a change in system information in at least a part of the first communication network;
sending a second indication from the second communication network to a wireless transmit/receive unit (WTRU), the second indication indicating the change in the system information in the at least part of the first communication network; and
obtaining the system information from the first communication network by the WTRU in response to the second indication.

19. The method of claim 18, wherein the first indication from the first communication network is sent from a mobility management entity of the first communication network.

20. The method of claim 18, wherein the WTRU obtains the system information of the first communication network upon transitioning to an idle mode with the second communication network.
